(19) United States
(12) Patent Application Publication
(10) Pub. No.: US 2019/0258818 A1
(43) Pub. Date: Aug. 22, 2019

(54) SMART ACCESS CONTROL SYSTEM FOR IMPLEMENTING ACCESS RESTRICTIONS OF REGULATED DATABASE RECORDS BASED ON MACHINE LEARNING OF TRENDS

(71) Applicant: ConsumerInfo.com, Inc., Costa Mesa, CA (US)

(72) Inventors: Nelson Yu, El Monte, CA (US); Gregory Thomas Olson, Trabuco Canyon, CA (US); Michelle Felice-Steele, Woodland Hills, CA (US); Roman Bercot, Aliso Viejo, CA (US); Edgar Uaje, Costa Mesa, CA (US)

(21) Appl. No.: 15/426,985

(22) Filed: Feb. 7, 2017

Related U.S. Application Data
(60) Provisional application No. 62/292,816, filed on Feb. 8, 2016.

(51) Int. Cl. G06F 21/62; G06F 21/31; G06N 99/00; G06N 5/04

(52) U.S. Cl. CPC G06F 21/6245; G06F 21/31; G06Q 40/025; G06N 5/04; G06N 99/005

(57) ABSTRACT

Methods and systems are provided for determining an action or recommendation in response to a request for information on an individual. A user may provide preferences and authentication data for responding to these requests. Historical information on an individual's typical response to such requests can also be used to determine the appropriate response. A community of other individuals that share a characteristic with the individual may be assessed for preferences and authentication. Information related to the requester requesting the data may also be used. An alert may then be generated and provided to the individual based on retrieved contact information associated with the individual.

### CROSS-REFERENCE TO RELATED APPLICATIONS

This application claims the benefit of U.S. Provisional Application No. 62/292,816 filed Feb. 8, 2016 under 35 U.S.C. § 119(e). The above identified application is hereby incorporated by reference in its entirety.

### TECHNICAL FIELD

Among other things, this disclosure describes systems and methods for providing controlled access when an entity requests data associated with the individual and providing the individual with information that will enable a more informed decision on the request for data.

### DESCRIPTION OF THE RELATED ART

Credit bureaus may provide users with the ability to limit access to the user's credit data, such as through completion of forms and manually providing identification information (e.g., birth certificate, passport, etc.). User's may have the ability to request access restrictions on credit data, such as via a lock or unlock, or freeze or unfreeze. When a credit file is unlocked, for example, information in the file can be accessed by third parties that have a permissible purpose to access the user's credit data, such as under the Fair Credit Reporting Act (FCRA) in the United States.

### SUMMARY

The systems and methods described herein allow users to receive more information to make better decisions and to further control access to data related to the user (e.g., regulated data stored in a secured third party database) through interaction on a mobile device (or other computing device), such as to provide a touch gesture on the mobile device that causes the user's data to be accessible to a third party.

For example, in some embodiments such a system may include a computing system for automating access to regulated data of a user from a third party requesting entity based on machine learning, the system comprising: a data store storing a plurality of regulated user profiles, each including user attributes associated with respective of a plurality of users; a computer processor executing software instructions causing the computing system to: receive an inquiry request from a third party requesting entity, the inquiry request including personally identifiable information of a user and request for regulated data of the user from a regulated user profile of the user in the data store; identify a user profile of the user based at least on the personally identifiable information of the user; determine a plurality of attributes of the user in the identified user profile; determine a set of other users each having the same determined plurality of attributes, wherein the set of other users have behaviors similar to the user; for the determined set of other users, access information regarding previous requests for regulated data of the respective other users, the accessed information indicating at least: entities that requested regulated data of the other users; for each access request, whether access to the user's regulated data was authorized or denied; for each access request, whether a relationship between the respective other user and the corresponding requesting entity was formed after the access request; for each access request, any feedback from the associated other user indicative of whether the access authorization or denial was desired; based at least on the accessed information, determining an access control model for application to the inquiry request for the user's regulated data; applying the determined access control model to at least some of the user profile attributes and at least some attributes of the third party requesting entity, wherein an output of the access control model indicates one of: an automated action of authorizing the inquiry request; an automated action of denying the inquiry request; a recommended action of authorizing the inquiry request; a recommended action of denying the inquiry request; if the output includes an automated action, initiating the automated action; if the output includes a recommended action, generate an transmit an electronic notification to the user device, the electronic notification configured to active an application on the user device to display the alert regardless of the current activity of the user device, the alert including a selectable option to allow the inquiry request, a selection option to deny the inquiry request, and at least some of the accessed information regarding the determined set of users that had a significant impact on determination of the output of the access control model.

In some embodiments, the trained model is a trained neural network. In some embodiments, the computing device is further configured to: update the trained model, wherein to update the trained model, the computing device is further configured to: obtain interaction history data indicative of a community member's interaction to alerts in response to inquiry requests; determine, from the interaction history data, a degree of interaction to the inquiry request; update the trained model based at least in part on the degree of the interaction to the inquiry request. In some embodiments, the user profile is associated with the community profile based on at least one of: demographic data, sex, race, economic status, age, level of education, income level and employment, psychiatric data, medical data, a personality trait, an interest, values, attitudes, lifestyles, opinions, preferences, likes or dislikes, predilections, purchase history, browser history, browser data, financial history, financial data, credit history, credit data, credit score, or personal history.

Some embodiments include a computer-implemented method comprising: receiving user information from a user device, wherein the user information includes at least one of: preference data or authorization data; identifying a user profile associated with the user; storing in the data store the received user information such that the user profile is associated with the user information; receiving an inquiry request from a requesting entity, wherein the inquiry request includes a request for data associated with the user; identifying the user profile associated with the user; applying the user information associated with the user profile to the inquiry request, wherein applying the user information comprises: identifying the preference data or authorization data associated with the user profile; determining the preference data or authorization data associated with the user profile that is applicable to the inquiry request; applying the preference data or authorization data associated with the user profile to the inquiry request; determining whether the application of the preference data or authorization data associated with the user profile exceeds a threshold value; in response to determining that the application of the preference data or authorization data associated with the user profile exceeds the threshold value, generating a second alert for delivery to the user, the second alert including: information identifying the requesting entity; a user interface element enabling the user to transmit the data associated with the user, the user interface element responsive to touch input of the user to monitor a time period of touching the user interface element, wherein the alert is generated (a) substantially in real time when the request for data associated with the user is received and (b) before or contemporaneously with a processing by a credit bureau of the request for data associated with the user; in response to determining that the application of the preference data or authorization data associated with the user profile does not exceed the threshold value, generating a second alert for delivery to the user, the second alert including: preventing access to the data associated with the user by the requesting entity.

In some embodiments, the alert is generated in association with a credit monitoring service. In some embodiments, the alert comprises data that activates software components on a user's remote device to alert the user in real time. In some embodiments, unlocking the credit file based on the preference or authorization data. In some embodiments, unlocking a portion of the credit file based on the preference or authorization data. In some embodiments, unlocking the credit file for only the requesting entity for the inquiry request based on the preference or authorization data. In some embodiments, the user information includes one or more of: transaction data, credit data, and personal data. In some embodiments, the user profile comprises a trained neural network, trained to output a score indicative of the user's preference or authorization. In some embodiments, the authorization data includes at least one of: a randomly generated code, a bar code, a QR code, a password, a user input through a user interface, or a biometric input. In some embodiments, the preference data includes at least one of: a complete block of access, a complete allow of access, a partial access, a partial block, an access for a period of time, a block of access for a period of time, or access rights based on another consumer. In some embodiments, the inquiry request is a request for at least one of: credit marketing offers, soft inquiries on credit data, or hard inquiries on credit data.

Some embodiments include a computer-implemented method comprising: receiving an inquiry request from a requesting entity, wherein the inquiry request includes a request for data associated with the user; identifying a requester profile associated with the requesting entity; applying the requester profile associated with the requesting entity to the inquiry request, wherein applying the requester profile comprises: identifying preference data or authorization data associated with the requester profile; applying the preference data or authorization data associated with the requester profile to the inquiry request; determining whether the application of the preference data or authorization data associated with the requester profile exceeds a threshold value; in response to determining that the application of the preference data or authorization data associated with the requester profile exceeds the threshold value, generating a second alert for delivery to the user, the second alert including: information identifying the requesting entity; a user interface element enabling the user to transmit the data associated with the user, the user interface element responsive to touch input of the user to monitor a time period of touching the user interface element, wherein the alert is generated (a) substantially in real time when the request for data associated with the user is received and (b) before or contemporaneously with a processing by a credit bureau of the request for data associated with the user; in response to determining that the application of the preference data or authorization data associated with the requester profile does not exceed the threshold value, generating a second alert for delivery to the user, the second alert including: preventing access to the data associated with the user by the requesting entity.

In some embodiments, the preference data or authorization data includes historical data of users indicative of the users' previous preference or authorization applied to the requesting entity. In some embodiments, the data include at least one of: a credit unfreeze or a credit unblock, and wherein preventing access to the data includes at least one of: a credit freeze or a credit block.

### BRIEF DESCRIPTION OF THE DRAWINGS

FIG. 1 is a block diagram illustrating an example configuration of a system that provides real-time user alerts in response to credit inquiry requests with unlock authorization.

FIG. 2 is a block diagram illustrating one embodiment of a credit access control system that is in communication with user computing device and a plurality of credit bureaus that are representative of any quantity of credit via a network.

FIG. 3 is a flowchart illustrating one embodiment of a method for determining a response to an inquiry request based on a user profile.

FIG. 4 is a flowchart illustrating one embodiment of a method for determining a response to an inquiry request in response to a credit block.

FIG. 5 is a flowchart illustrating one embodiment of a method for generating, updating, and applying a trained model.

FIG. 6 is a flowchart illustrating one embodiment of a method for using a community profile to determine an action in response to a request for user credit information.

FIG. 7A is a user interface illustrating one embodiment of a real-time inquiry alert.

FIG. 7B is a user interface illustrating one embodiment of a proactive block.

FIG. 7C is a user interface illustrating one embodiment of a smart block.

FIG. 8A-F are user interfaces associated with an example implementation of a smart access technology, such as is discussed herein.

These and other features will now be described with reference to the drawings summarized above. The drawings and the associated descriptions are provided to illustrate certain embodiments and not to limit the scope of the invention. Throughout the drawings, reference numbers may be re-used to indicate correspondence between referenced elements. Note that the relative dimensions of the following figures may not be drawn to scale.

### DETAILED DESCRIPTION

Various embodiments of systems, methods, processes, and data structures will now be described with reference to the drawings. Variations to the systems, methods, processes, and data structures which represent other embodiments will also be described. Although several embodiments, examples and illustrations are disclosed below, the inventions described herein extend beyond the specifically disclosed embodiments, examples and illustrations and includes other uses of the inventions and modifications and equivalents thereof. Embodiments are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the invention. In addition, various embodiments can comprise several novel features and no single feature is solely responsible for its desirable attributes or is essential to practicing the inventions herein described.

### Definitions

In order to facilitate an understanding of the systems and methods discussed herein, a number of terms are defined below. The terms defined below, as well as other terms used herein, should be construed to include the provided definitions, the ordinary and customary meaning of the terms, and/or any other implied meaning for the respective terms. Thus, the definitions below do not limit the meaning of these terms, but only provide exemplary definitions.

The terms “user,” “individual,” “consumer,” and “customer” should be interpreted to include single persons, as well as groups of individuals, such as, for example, married couples or domestic partners, organizations, groups, and business entities. Additionally, the terms may be used interchangeably. In some embodiments, the terms refer to a computing device of a user rather than, or in addition to, an actual human operator of the computing device.

User Input (also referred to as “Input”) generally refers to any type of input provided by a user that is intended to be received and/or stored by one or more computing devices, to cause an update to data that is displayed, and/or to cause an update to the way that data is displayed. Non-limiting examples of such user input include keyboard inputs, mouse inputs, digital pen inputs, voice inputs, finger touch inputs (e.g., via touch sensitive display), gesture inputs (e.g., hand movements, finger movements, arm movements, movements of any other appendage, and/or body movements), and/or the like.

A user device (also referred to herein as a “user computing device”) generally includes any device of a user, such as an electronic device through which an offer from an offer provider may be displayed (e.g., via software and/or a site of a digital display entity). User devices may include, for example, desktop computer workstation, a smart phone such as an Apple iPhone or an Android phone, a computer laptop, a tablet such as an iPad, Kindle, or Android tablet, a video game console, other handheld computing devices, smart watch, another wearable device, etc. A user device may include the same or similar components to those discussed below with reference to the digital targeting system. In some discussions herein, a “user” refers to one or both of a user device and the individual that is operating the user device. Thus, if an input is received from a user, it may be received from an individual operating a user device.

The term “regulated data” generally includes information regarding users that is stored by an entity and is subject to external regulations (such as set by a government agency) that restrict how the user information may be used (e.g., accessed, updated, shared, etc.) outside of the storing entity. Regulated user data generally is useful in validating users to receive offers for certain goods or services, but may include sensitive user data that should be protected to a greater degree than publicly available user information. Thus, in some embodiments, dissemination, sharing, and/or any other access to regulated user data may be controlled closely by the storing entity in order to reduce risks associated with improper use of the regulated data, such as any sharing of regulated user data that violates the relevant regulations. Accordingly, while regulated user data may be optimal for determining certain characteristics or propensities of users, such as determining risks associated with issuing a credit account to users, sharing of regulated user data with offer providers, digital display entities, and/or others that might be involved in related marketing or communications to the user may be limited to include only the minimum required regulated user data or no regulated user data. Regulated data may include credit data of the user, such as a credit report or credit file. Regulated data may also include data related to: Family Educational Rights and Privacy Act (FERPA), Health Insurance Portability and Accountability Act (HIPAA), Social Security Numbers (SSNs), or Gramm Leach Bliley Act (read about GLBA Compliance at U-M). Regulated data may also include data related to the individual (and/or to other entities/persons related to the individual) that an individual may want control the access of the data to other entities. The terms regulated data and credit data may be used interchangeably.

“Credit data” generally refers to user data that is collected and maintained by one or more credit bureaus (e.g., Experian, TransUnion, and Equifax) and is subject to regulatory requirements that limit, for example, sharing of credit data to requesting entities based on the Fair Credit Reporting Act (FCRA) regulations in the United States and/or other similar federal regulations. “Regulated data,” as used herein, often refers to credit data as an example of such regulated data. However, regulated data may include, but is not limited to, other types of data, such as HIPPA regulated medical data. Credit data can describe each individual data item associated with a user, e.g., an account balance, or any combination of the individual's data items. “Credit file” and “credit report” generally refer to a collection of credit data associated with a user, such as may be provided to the user, to a requesting entity that the user has authorized to access the user's credit data, or to a requesting entity that has a permissible purpose (e.g., under the FCRA) to access the users credit data without the user's authorization.

Certain discussions herein refer to a user “profile,” which generally refers to any set of user information, such as credit data of a user in some embodiments. Thus, a user profile may be credit data of the user. In other embodiments, a user profile may include additional information of the user, such as demographic, marketing, psychographic, etc., information that may be obtained from data sources other than a credit bureau.

A credit report freeze (also referred to herein as a “credit freeze,” “report freeze,” a “freeze,” or the like) generally refers to blocking access to a user's credit data by third parties (e.g., someone or an entity other than the user associated with the credit data), such as credit data in a credit file or credit report. A credit report freeze is often executed in accordance with various security freeze laws. For example, a credit report freeze may be implemented in view of a single state's law to enact security freezes. A credit report freeze may require an individual to provide a personal identification (PIN) code and/or other authentication information (username and password, biometric data, etc.) to initiate the freeze. In some embodiments, state-regulated fees and or credit bureau fees may be charged to the user that requests a credit freeze. When a user's credit report is frozen, certain accesses to the user's credit data that are typically permissible, such as for pre-qualification of the user for a line of credit, may be blocked. In some embodiments, user initiated credit monitoring may or may not be allowed if the user's credit report is frozen. A credit freeze can prevent thieves and data hackers from accessing credit information

A credit report lock (also referred to herein as a “credit lock,” “report lock”, “lock,” or the like) generally refers to blocking access to credit data of a user associated with the credit data. A credit report unlock (also referred to herein as a “credit unlock lock,” “report unlock”, “unlock,” or the like) generally refers to allowing access to credit data that has previously been locked. A credit lock can allow customization beyond what is allowed with a credit freeze, such as to allow the user to proactively control accesses to their credit data, such as through authorizing access to only a particular entity, for a limited time period, etc., as discussed herein. A credit lock is generally implemented by one or more credit bureaus and, thus, may not be limited by government regulations, such as those that apply to a credit freeze. Advantageously, a credit report lock may prevent access to only particular items of credit data within a credit file of a user. The user's proactive controls may include, but not limited to, blocking credit inquiry requests from only a certain entity or entities and, similarly, may allow access to credit data from only a certain entity or entities. A credit report lock may be for a particular period of time, such as a temporary lift (e.g., 1 hour) on the credit report lock, or purpose.

A “fraud alert” generally refers to an alert condition associated with a user's credit data that requires the credit bureau to inform any requesting entity of the user's credit data that the user has placed a fraud alert on their credit data and, thus, the requesting entity should confirm identity of the user. Fraud alerts may be requested at each of multiple credit bureaus so that credit data requested from any one credit bureau are subject to the fraud alert. Fraud alerts may last a predetermined time, such as 90 days, and then is automatically removed from the user's credit file. Thus, if a user wishes to keep the fraud alert in place, the user should repeat the fraud alert at each credit bureau about every 90 days.

While much of the description herein refers to a credit report lock and unlock, similar functionality and advantages can equally be applied to credit report freezes, lifts, and thaws, and vice versa. Thus, any discussion of credit locks and unlocks should be construed to include similar implementations with credit freezes, fraud alerts, lifts, thaws, unfreezes, as well as any other types of access control processes that may be applied to regulated data.

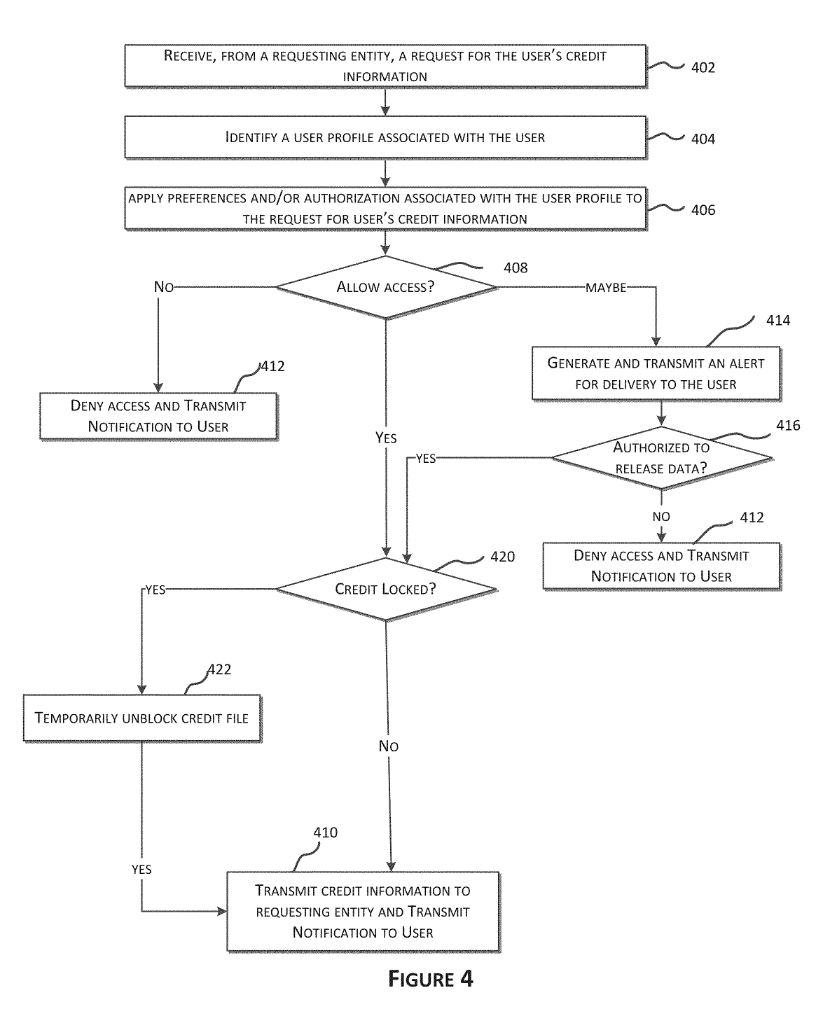

An “alerts” and/or “notification” (which may be used interchangeably) generally refer to information transmitted from one entity to another, such as an electronic message that is automatically transmitted from a credit monitoring device to a device operated by a user whose credit data has been requested. The alert and/or notification can be transmitted at the time that the alert and/or notification is generated or at some determined time after generation of the alert and/or notification. When received by the user's device, the alert and/or notification can cause the device to display the alert and/or notification via the activation of an application on the device (e.g., a browser, a mobile application, etc.). For example, receipt of the alert and/or notification may automatically activate an application on the device, such as a messaging application (e.g., SMS or MMS messaging application), a standalone application (e.g., a credit monitoring application provided to the user by the credit report access control system), or a browser, for example, and display information included in the alert and/or notification. If the device is offline when the alert and/or notification is transmitted, the application may be automatically activated when the device comes online such that the alert and/or notification is displayed, or may reroute the notification to an alternative computing device (e.g., wireless device) to notify the user. As another example, receipt of the alert and/or notification may cause a browser to open and be redirected to a login page generated by the system so that the user can log in to the system and view the alert and/or notification. Alternatively, the alert and/or notification may include a URL of a webpage (or other online information) associated with the alert and/or notification, such that when the device (e.g., a mobile device) receives the alert, a browser (or other application) is automatically activated and the URL included in the alert and/or notification is accessed via the Internet. The alert and/or notification may be determined based on preferences stored in a data store. For example, a user may sign up for a publish/subscribe service or a credit monitoring service 108 that may be configured to identify changes to credit data. Upon enrollment, the individual may additionally select an option to be notified of credit data inquiries and a selection of preferences for receiving alerts/notifications (e.g., as discussed with reference to block 425 of FIG. 4 below).

A “module” generally refers to logic embodied in hardware or firmware, or to a collection of software instructions, possibly having entry and exit points, written in a programming language, such as, for example, Java, Lua, C, C++, or C#. A software module may be compiled and linked into an executable program, installed in a dynamic link library, or may be written in an interpreted programming language such as, for example, BASIC, Perl, or Python. Software modules may include, by way of example, components, such as class components and task components, processes, functions, attributes, procedures, subroutines, segments of program code, drivers, firmware, microcode, circuitry, data, databases, tables, arrays, and variables. It will be appreciated that software modules may be callable from other modules or from themselves, and/or may be invoked in response to detected events or interrupts. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage. When executed by the access control system 110, modules may allow the access control system 110 to perform operations, such as storing data, accessing stored data, modifying stored data, communicating with other computing devices and systems, and other operations described herein. For ease of explanation, the modules may be referred to as performing an operation or a method, even though other systems and/or components of the access control system 110 may actually perform the operation or method in response to executing software of a module, for example.

A “requesting entity” generally refers to any entity that is interested in a user's data. For example a requesting entity may include a credit requesting entity, such as lenders, car dealers, brokers, retailers, landlords, and/or any other entity that is interested in user credit data.

A “trained model” (or simply “model”, or “access model”) generally refers to any algorithms, functions, techniques, models, systems, etc., that can be used to generate output scores indicative of a preference or authorization for a user, system, a community, or a requesting entity. For example, a neural network (e.g., LSTM network), a Baysian network, or a probability model (e.g., Markov model or other stochastic model) may be used to determine an output score, which may be used to determine a recommended or automatic action be taken by a computing system. Machine learning may be implemented on the trained model, such that the trained model is generated and/or updated based on historical and/or training data.

For example, a model may be used to generate an “action” or “response” to inquiry requests. Actions may be in the form of recommended actions, which are provided to the user as recommendations for allowing or blocking inquiry requests, or automated actions, which automatically executes a determined allowance or blocking of an inquiry request without further input from the user. Any discussion of a recommend action herein may also be implemented as an automated action in some embodiments, and vice versa.

Thus, a model may be used to determine how to respond to an inquiry request for a particular user, such as based on how other similar users have responded to similar inquiry requests in the past. Outcome data may be received by the system to further train and optimize future performance of the model. For example, a recommended response to a credit inquiry may be compared against whether the user actually allowed the inquiry request to be fulfilled and/or feedback from the user regarding accuracy of the recommended action (e.g., was the recommendation what the user really wanted to do?) to better tune the predictive model for future use (e.g., for that particular user and/or other similarly situated users). In some embodiments, training data may be used to train a neural network (e.g., a training vector corresponding to retired people with assets over $10,000,000 with predetermined output values indicative of blocking inquiry requests related to marketing offers).

An action may be determined, e.g., using an action determination model, based on various data associated with the requesting entity, the user, and/or any other data related to the requesting entity or user. For example, various preferences that may be considered in determining an automatic or recommended action are discussed below. For example, previous actions in allowing or blocking credit inquiries from a particular requesting entity (or group of similar requesting entities) may be analyzed to determine a recommend action. In another example, a requesting entity's attributes, such as a preference of a requesting entity to deny offers to individuals with a credit score of less than 600, may be used to determine a recommended action in response to an inquiry request from that requesting entity (e.g., such as based on whether the particular user has a credit score above 600). In another example, an action may be determined based on information related to a third party of the requesting entity, such as a credit card company associated with a marketing company that is making the inquiry request. Noted below in further detail are further details regarding some factors that may be used in generating an automated (or recommended) action.

In some embodiments, an automated or recommended action may be based on an access indication that may be provided by the requesting entity and/or the user. For example:
Auto approve access to credit report if user has provided a randomized code generated by the access control system (and/or credit bureau) to be included in the credit inquiry request. The code may be usable for a specified period of time only.
Auto approve access to credit report if user has provided a bar code or QR Code generated by access control system (and/or credit bureau) to be included in the credit inquiry request. The code may be usable for a specified period of time only.
Auto approve access to credit report if consumer has “tapped” to connect to the requesting entities (e.g., a financial institution) application process that resulted in the inquiry request. For example, the user going through a credit application at a financial institution may provide explicit or implicit authorization for the requesting entity to access the user's credit data.

In some embodiments, an automated or recommended action may be based on information that may be provided from another software application on the user device. For example, a credit monitoring application on the user's mobile phone, which receive the access recommendation, may provide information to the access control system that is used to determine whether and how much user information should be provided to the requesting entity. In such embodiments, additional data from the application, beyond credit data that is provided by one or more credit bureaus, may be provided to the requesting entity also. For example:
A user's data stored by a mobile application (e.g., a credit monitoring application that receives the credit inquiry notifications from the access control system and/or a third party application) may be shared with a requesting financial institution, along with an automatic credit access approval if the user has already (e.g., is currently) authenticated by the mobile application. In some embodiments, the mobile application may be configured to provide auto-population data usable by the requesting entity to populate (partially or fully) the credit application from the financial institution.
A user's data stored by a mobile application (e.g., a credit monitoring application that receives the credit inquiry notifications from the access control system and/or a third party application) may be shared with a requesting financial institution after the user approves via the mobile application. For example, a simple button tap, slide gesture, etc., may be provided by the user to approve access to the user's credit data and additional user data from the mobile application (or provider of the mobile application via network/cloud storage). In some embodiments, the mobile application may be configured to provide auto-population data usable by the requesting entity to populate (partially or fully) the credit application from the financial institution.

A “community” generally refers to a group of users that have some predetermined and/or automatically derived similarities. Users may be included in a community based on similar characteristics, such as geographic area of residence, geographic area of work, sex, race, economic status, age, household size, level of education, income level (reported or estimated, individual or household), profession, employment, psychiatric data, medical data, personality trait, interests, life stage, values, attitudes, lifestyles, opinions, preferences, likes or dislikes, predilections, purchase history, browser history, financial history and data, credit history and data, personal history and data, other activity data, and/or any other data associated with the user. A community may be defined based on one or more of such factors, such as based on a calculation of these factors (e.g., algorithm, weighting). Criteria for determining community members may be determined based on user preferences, for example, and/or may be automatically optimized over time as the system learns more about how communities can more accurately be defined.

A “preference” generally refers to an indication from a user of how recommendations or automated actions should be determined by the system. For example, a preference may include a rule, algorithm, description of credit sharing preferences. For example, a preference of a user may indicate that the system automatically blocks (or allows) inquiry requests based on any one or more of:
prior inquiry requests from other users (e.g., a community of users), such as how those other users responded to similar credit inquiries (e.g., from the same or similar requesting entity),
credit history of the user
credit history of the community
a whitelist of requesting entities that should always be allowed access
a blacklist of requesting entities that should always be denied access
on impact on the user's credit file (e.g., hard vs. soft inquiries)
expected impact on the user's credit score of completing the associated transaction (e.g., affect on the user's credit score of opening a new credit account for which the inquiry request is made)
a period of time (e.g., blocking all requesting between 10 pm PST and 6 am PST, or from 10:00 AM PST 01/01/2017 2:00 PM PST 01/17/2017)
uses of the credit data (e.g., account opening, marketing of services, etc.). For example, preference may block credit resellers.
particular purpose/transaction (e.g., a car purchase, new credit card account, etc).

These preferences may be used in any combination to determine a recommended action to be provided to the user or an automated action to be performed by the access control system. The preference may be stored and accessible to an access control module so that automated or recommended actions may be determined in real-time in response to an inquiry request.

Preferences may be defined by a user and/or may be automatically determined, such as based on a machine learning model. Thus, user preferences that are applied to a particular inquiry request may include one or more preferences that were directly provided by the user and one or more preferences that have been derived by machine learning and which may evolve over time.

“Authentication” generally refers to determining or confirming identity of an entity, such as determining that an entity that authorizes sharing of a particular user's credit data is really that particular user. In some embodiments, authentication of a user, and/or a level of authentication provided by the user, may be used in making a determination of an automated or recommended action to perform in response to an inquiry request by the user. Authentication may be provided in various forms or types, such as various forms of identifications, whether inputted by a user or retrieved from a database. For example, authentication information may include entry of a code randomly generated by another entity, a bar code, a QR code, a username, a password, user interaction to a user interface, biometric information, the means or the origin of the authentication information (e.g., authentication information received from a trusted entity), and the like. Although preference and authentication is used throughout the disclosure, preference and authentication may be interchangeable where applicable.

### Introduction and Example Embodiments

In some embodiments, a user may provide information to a credit bureau that confirms their identity, as well as possibly a lock/unlock identifier (e.g., a number or alphanumeric code) in order to initiate locking or unlocking of their credit file. Unfortunately, this can be a tedious, slow, and inconvenient process for many reasons. For example, the process may be quite slow as it may require human review of the authentication documents. There may also need to be several layers of security features to authenticate the user, such as providing original copies of documents (e.g., birth certificates, passports, etc.), biometric sensors, passwords and pins, and/or responding to questions. The user would also have to remember such passwords and pins, and responses to the answers. The forms or process of locking or unlocking may also be long and require a lot of information from the user. The forms may also require documents that may take time and effort to obtain (e.g., bank statement, utility bill, etc.). Furthermore, the lock or unlock feature may require a fee or payment from the user each and every time a lock or unlock request is sent. Also, sending and receiving information for such a request over the phone, via mail or electronically, may subject such information to security risks (e.g., hacking) and may lead to more identity theft or fraud. The rules for a freeze and unfreeze may also differ from state to state, further complicating the process of securing user data. Thus, when moving from one state to another, the rules for locking and unlocking your credit file may be quite different.

In view of these technological shortcomings, when a user wishes to provide a third party with access to credit data that is locked, they cannot do so. Additionally, users may forget that they locked their file and when applying for credit (or otherwise wanting to allow access to credit data), would simply be prevented from accessing their credit file until the arduous and time-consuming process of unlocking the credit data is performed. Users would have to identify what happened (e.g., whether the credit file was locked, frozen, or some other reason such as incorrect information submitted) and take necessary steps to release the credit file that prolong the process and may dissuade a user from continuing.

Additionally, users have no control over their credit files once a lock is performed. For example, after a lock has been placed, the user is unaware of credit inquiries (requests by third parties to access credit data) received by the credit bureaus and, thus, cannot provide access to third parties that the user wishes to grant access to. For example, although the user may have locked their credit file for other security purposes (such as identify theft), the user may need to allow access their credit file for other purposes (such as applying for a credit card). However, based on the technological shortcomings noted above, the user may decide not to pursue the credit card. Moreover, after completing the arduous process of unlocking their credit file, the user may forget or just not be dedicated enough to spend the time on the similar process of re-locking their credit file.

Users may also find it inconvenient to have to memorize a separate identifier that is provided by the credit bureau for each credit bureau that maintains a credit file for the user. Moreover, the user may forget an identifier he or she may need to request a new identifier by, for example, phone or certified mail from the credit bureau, which can result in a delay in locking their file. Additionally, when the user wishes to unlock their file they may need to wait a specified period of time, often three days, for the file to be unlocked. Besides imposing risks to a user's credit file, these delays may cause lenders, such as those looking to provide instant credit, to lose out on credit opportunities. Furthermore, users may not want to reveal their identifiers in a public area at the point of sale.

In merchant environments, such as department stores, credit file locking and unlocking can be especially problematic. For example, a store may offer a credit card, debit card, or store loyalty card, for example, to a user at a point of sale. The user may decide that applying for the store card is not worthwhile because their credit file is locked and unlocking the file will take significant time and effort (e.g., the user may be required to call each of one or more credit bureaus and provide credit bureau specific credit file unlock codes to each credit bureau, pay a fee to each of the credit bureaus, etc., and waiting significant time periods for implementation by respective credit bureaus). Alternatively, a user may apply for the store card using the credit application process, only to discover that their credit file is locked. In this situation, the user may then decide not to proceed further with the application process because of the above-noted technological shortcomings in existing credit file control systems. As a result, merchants may lose out on significant sales and credit opportunities.

In addition, the lock and unlock functionality has traditionally been based on solely a user's request for a lock or unlock of their credit data. Thus, the decision to lock or unlock rests on the information currently available to the individual. Thus, there is a need for the user to have more information regarding the inquiry, the requesting entity requesting the inquiry, past history of the individual, and/or history of other users to be able to be better equipped to make a more informed decision on the inquiry request for credit data. Such data, such as data associated with a group of other users with similar demographic profiles (e.g., similar credit score and estimated income) could not be retrieved manually, especially within a time frame that would be usable by the user in providing an immediate access decision. Users would also not have access to information on how other similar customers have acted or have customized their access to data.

The systems and methods described herein equip users with more control and information to make better decisions and to allow further options of control in response to inquiry requests to regulated data of the user (stored in a secured third party database) through interaction on a mobile device (or other computing device), such as to provide a touch gesture on the mobile device that causes the users regulated data to be accessible to a third party. Access rights to the regulated data may be provided in real-time (or near real-time) in response to a request for the data from a third party, for example. The system may allow a user to respond to an alert or notification that is automatically sent to the computing device of the user in response to a request for a secure regulated data of the user.

In one embodiment, the regulated data comprises credit data that is stored by one or more credit bureaus and the access controls available to the user include locking and unlocking of the user's credit data, such as based on user preferences, community models, requesting entity data, etc. In some embodiments, systems and methods described herein allow users to unlock their credit files in real-time or near real-time. Upon receiving a request to access a credit file from a requesting entity, the system may determine whether the credit file is locked, frozen, or otherwise prevented from dissemination. In response to determining that the credit file is not locked, frozen, or otherwise prevented from dissemination, the system may proceed with the release of credit data or providing a different set of options for the individual. However, if the credit file cannot be sent to the requesting entity, the system may notify the user or assess the circumstances to make a decision whether to automatically allow or deny the request, or whether to provide a recommendation to the user (e.g., to either allow or deny the request) and perform the action based on input from the user. The system may determine notification preferences of the user and transmit an alert according to such preferences. The alert may notify the user that an inquiry to the credit file has been sent. The alert may activate software components on a user's remote device to provide immediate time-sensitive information when the user's other devices are not available (e.g., other devices are not on his or her person, devices are off, devices do not have certain applications running). For example, an alert may activate a credit monitoring application on the user's mobile device, even when the mobile device is in a low power mode, to display alert information to the user so that a timely decision regarding allowing or blocking the inquiry request can be provided.

In some embodiments, the system may authorize an unlock, unfreeze, thaw, or lift of the credit file. U.S. Pat. No. 9,256,904, titled “Multi-bureau credit file freeze and unfreeze,” issued Feb. 9, 2016, which is hereby incorporated by reference in its entirety, describes additional details and options in allowing users to lock or unlock their credit files, such as through use of a personal identifier. The features and details included in U.S. Pat. No. 9,256,904 may be applied to various embodiments discussed herein.

In some embodiments, the system performs credit file locking and unlocking based on user, system, group, community, and/or requesting entity defined preferences. For example, a user preference may indicate that the user's credit file may be unlocked for a particular period of time for a particular type of requesting entity. The credit file may also be unlocked for a purpose or for a particular requesting entity. The unlock may be for only a portion or subset of the user's credit file, while a lock remains on the remainder of the credit file. U.S. Pat. No. 8,744,956, titled “Systems and methods for permission arbitrated transaction services,” issued Jun. 3, 2014, describes additional details and options associated with selective sharing of credit data, such as sharing for a period of time or purpose. The features and details included in U.S. Pat. No. 8,744,956 may be applied to various of the embodiments discussed herein.

In some embodiments, a recommended action may be calculated by an access control entity (or module) based historical information associated with the particular user or community of related users. For example, previous responses from the particular user or community to inquiry requests may be analyzed to determine whether an automatic action (e.g., automatic blocking) or recommend action (e.g., providing a notification to the user that, based on previous experience with the requesting entity the inquiry request should be blocked and providing the user with an option to indicate approval of the blocking recommendation) should be provided to the user. The machine learning may be implemented using techniques, models, or systems that can be used to generate output scores indicative of a preference or authorization for a user, system, a community, or a requesting entity (e.g., a trained model). For example, a neural network (e.g., Long Short Term Memory “LSTM” network), a Baysian network, or a probability model (e.g., Markov model or other stochastic model) to determine an output score.

Embodiments of the access control technology discussed herein may be particularly advantageous in merchant environments. For example, in point of sale environments a user may apply for a credit card (debit card, store loyalty card, or other account that requires access to credit data by the merchant). However, the credit file may be locked. In response to the merchant's inquiry for credit information, the system can automatically and in real-time generate and transmit alert data to a mobile device of the user, notifying the user of the inquiry and possibly provide a link to additional information regarding the user's credit data, the requesting merchant, or other relevant information. Then the system can allow the user to authorize an unlock of the credit file. The unlock can be customized. For example, the credit file may be unlocked for a particular purpose (e.g., applying for a credit card or more generally for a line of credit). The unlock may be for a particular duration (such as an unlock for an hour) and then may automatically re-lock thereafter. The unlock may be for a particular requesting entity (e.g., a trusted merchant identified by the user). The unlock may be directed toward a portion of the credit data. For example, a portion of the credit data that is necessary for the purpose of the inquiry may be released. A less intrusive portion of the credit file may also be released (e.g., such as credit score without total debt). By providing users with a simplified interface and an expedient mechanism for customized unlocking of their credit files, the system can increase credit opportunities for both the user and the merchant, while reducing risk of identity theft by allowing the user to easily keep their credit file locked. Furthermore, the system may also determine an automatic response based on a user's preference profile, a community profile, or a requesting entity profile. The automatic response may include a determination to allow or deny all or a portion of the inquiry request. The automatic response may include an alert providing the user with information on preferences of the individual, community data determined by the access control system, and/or information regarding the requesting entity.

### Example Workflow and Advantages

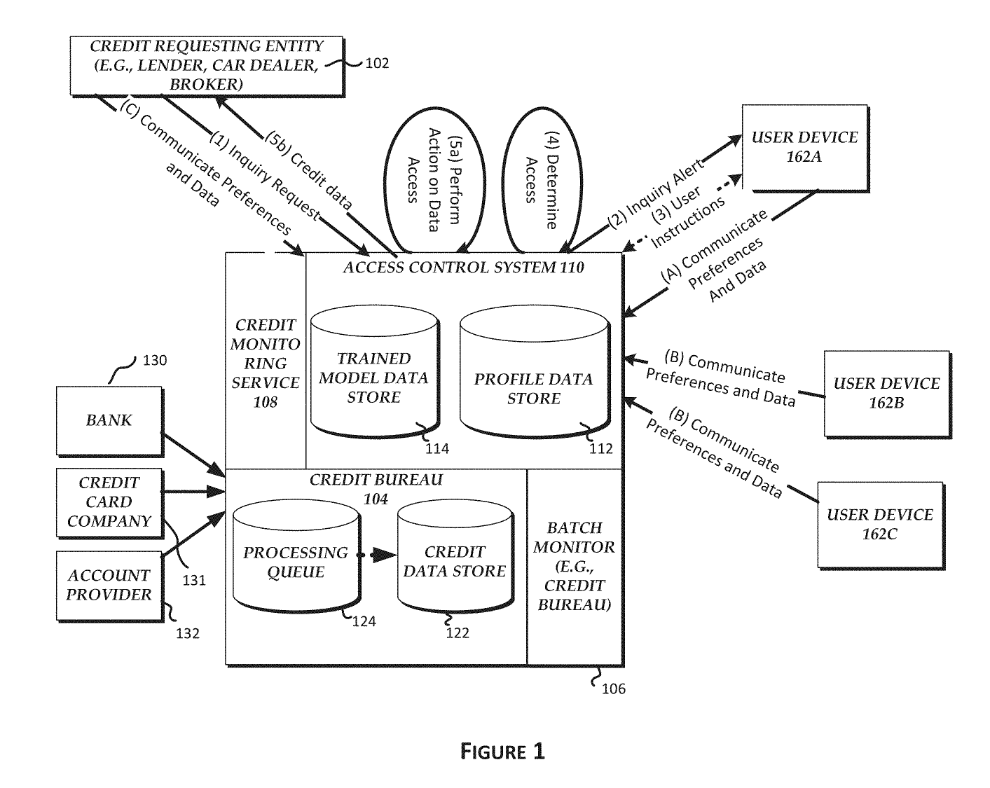

FIG. 1 is a block diagram illustrating an example configuration of a system that provides real-time information or alerts in response to credit inquiry requests. In the embodiment illustrated, credit event data is shown being received by a credit bureau 104 from various entities, such as a bank 130, a credit card company 131 and an account provider 132. Credit event data may additionally be received from lenders and/or other financial institutions (not illustrated). The credit bureau 104 includes a processing queue 124 for receiving and routing the incoming credit event data. Tradeline data, e.g., information regarding credit and debit accounts of the user, may be transmitted to the credit data store 122. For example, a credit module operated by the credit bureau 104 may determine appropriate credit data and other user information to be stored in a credit data store 122 based at least in part on the data received from the various entities 130-132.

The credit data store 122 may be monitored periodically, such as via a batch process, to identify changes to credit data stored by the credit bureau 104. For example, the credit bureau 104 may nightly scan the credit data store 122 for changes to user credit files. In one embodiment, the batch monitor 106 looks for changes to credit files of users that are enrolled in a credit monitoring service 108 of one or more affiliates of the credit bureau 104. A credit monitoring service 108 may generally include a service with which individuals maintain an account in order to be alerted when a change posts to the individual's credit data, which may include an inquiry being noted in the individual's credit data. In the embodiment of FIG. 1, a user credit monitoring service 108 performs and/or requests that the batch monitor 106 perform a batch process to identify changes to credit data associated with customers of the user credit monitoring service 108. For example, the credit monitoring service 108 may periodically pull identified credit changes and determine which alerts correspond to customers of the credit monitoring service 108. Once customers for particular changes are identified, information regarding the change may be transmitted to the user. A few hours to a few days may pass between the credit data being received by the credit bureau 104 and the provision of notifications to users regarding changes to the affected user. In some embodiments, the changes in credit data may be used in generating and updating a user profile, community profile, and/or requester profile.

Also shown in FIG. 1 are requests for user credit data that might be received by the access control system 110. Depending on the embodiment, the access control system 110 may be operated and/or controlled by the credit bureau 104 or may be operated and/or controlled by a separate entity, such that communications between the access control system 110 and the credit bureau 104 are via one or more network connections. Credit requesting entities, such as credit requesting entity 102, may include lenders, car dealers, brokers, retailers, landlords, and/or any other entity that is interested in user credit data. Requests for credit data are generally referred to herein as inquiries, inquiry requests or credit inquiry requests. In addition to providing the requested credit data (such as a credit report regarding the user) to the credit requester 102, inquiry requests may be recorded in the credit file of the user, which may be stored in credit data store 122 and/or profile data store 112. The profile data store 112 stores profile data related to a user, a community, and/or a requester (e.g., a user profile, a community profile, a requester profile). Thus, inquiry requests can be monitored by the batch monitoring processes that are performed by the credit bureau 104 (such as by batch monitor 106) and/or an affiliate of the credit bureau 104 (such as by credit monitoring service 108), which may include a credit data reseller or a third-party credit monitoring service. However, providing alerts in this manner may result in the customer of a credit monitoring service 108 receiving notification of an inquiry request days after the inquiry request was made. If the inquiry request was fraudulent (e.g., made by someone that was not authorized to receive credit data associated with the customer and/or to open a credit account in the name of the customer), the customer would be better served to receive the notification earlier, such that action may be taken to minimize damage to the customer's identity, finances and/or credit file. Additionally, if the user's credit file is locked, such that the credit file of the user is not provided to the requesting entity 102, a change (e.g., a soft or hard inquiry) in the credit data of the user may not be recorded and, thus, the user would not receive any indication of the received credit inquiry. As discussed below, the access control system 110 addresses this technological problem by providing a system and user interfaces that allow a user to receive alerts of credit inquiries, even when the user's credit file is locked, and determine desired actions to be taken in response to the credit inquiry. The access control system 110 may automatically decide to take desired actions based on the information available (e.g., user profile, user preferences or authentication, community preferences or authentication, requesting entity preferences or authentication).

In the embodiment of FIG. 1, (1) the credit requesting entity 102 sends an inquiry request to a credit monitoring system 108, which may include the access control system 110 or may be in communication with the access control system 110 (operated by the same entity as provides the credit monitoring or by a separate third party entity). The access control system 110 provides users with real-time notifications of inquiry requests. In this embodiment, (2) the access control system 110, which initially receives the inquiry request from the credit requesting entity 102 (or from the credit monitoring service), provides inquiry request notifications upon receipt of a new inquiry alert from a credit requesting entity 102. For example, the credit bureau 104 and/or credit monitoring service 108 may provide the access control system 110 with inquiry request information, which may be passed along to the corresponding user, regardless of whether the credit file of the user affected by the inquiry.

In the embodiment of FIG. 1, credit data of the user may be provided with an inquiry request notification prior to the credit monitoring service 108 providing the requested credit data to the credit requesting entity 102 and/or recording the inquiry request in the user's credit data (e.g., prior to storing data associated with the inquiry request in credit data store 122). In other embodiments, the access control system 110 may provide the inquiry request notifications substantially contemporaneously with recording the inquiry request in the user's credit data and/or retrieving credit data to provide to the credit requesting entity 102.

Credit inquiry alerts may be provided to the user in various manners, as described further below. For example, as illustrated in the example of FIG. 1, inquiry alerts generated by the access control system 110 may be sent to a user device 162A, 162B, 162C (collectively referred to herein as “162”). Similarly, (3) the user may access alert details by requesting additional information from the access control system 110.

The access control system 110 may retrieve contact information for the user from an account data store operated by a credit monitoring service 108, for example, which may include an email address, telephone number, account user name, etc. The access control system 110 may send or otherwise provide an alert to the user and/or a user device 162 associated with the user based on the retrieved contact information. Alerts may be delivered via any medium, such as, for example, an online portal that is accessible to alert members (e.g., a credit monitoring website), SMS text message, push notification to a mobile device (e.g., to a credit monitoring mobile application), email, printed digests, a mobile application, automated or personal telephone call, activation of software components on the remote device, activating an application on a user device, etc. In some embodiments, the alert may include detailed information associated with the inquiry, such as information identifying the credit requesting entity 102, the time of the inquiry, the data requested (e.g., whether a full credit report was requested), etc. In other embodiments, the alert may not include any specific information regarding the inquiry, but may notify the user that he should access his account with the credit monitoring service 108 and/or review his credit data with credit bureau 104 in order to obtain further details.

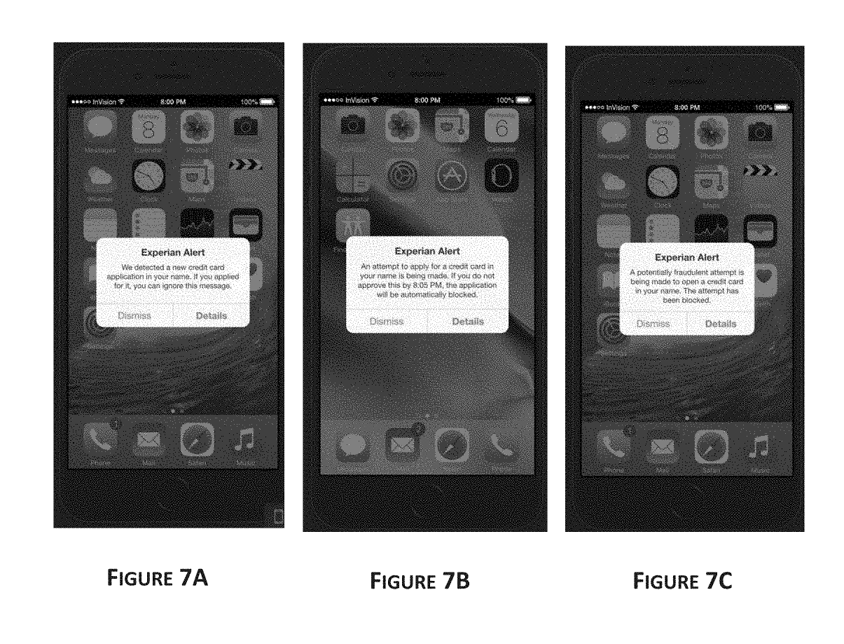

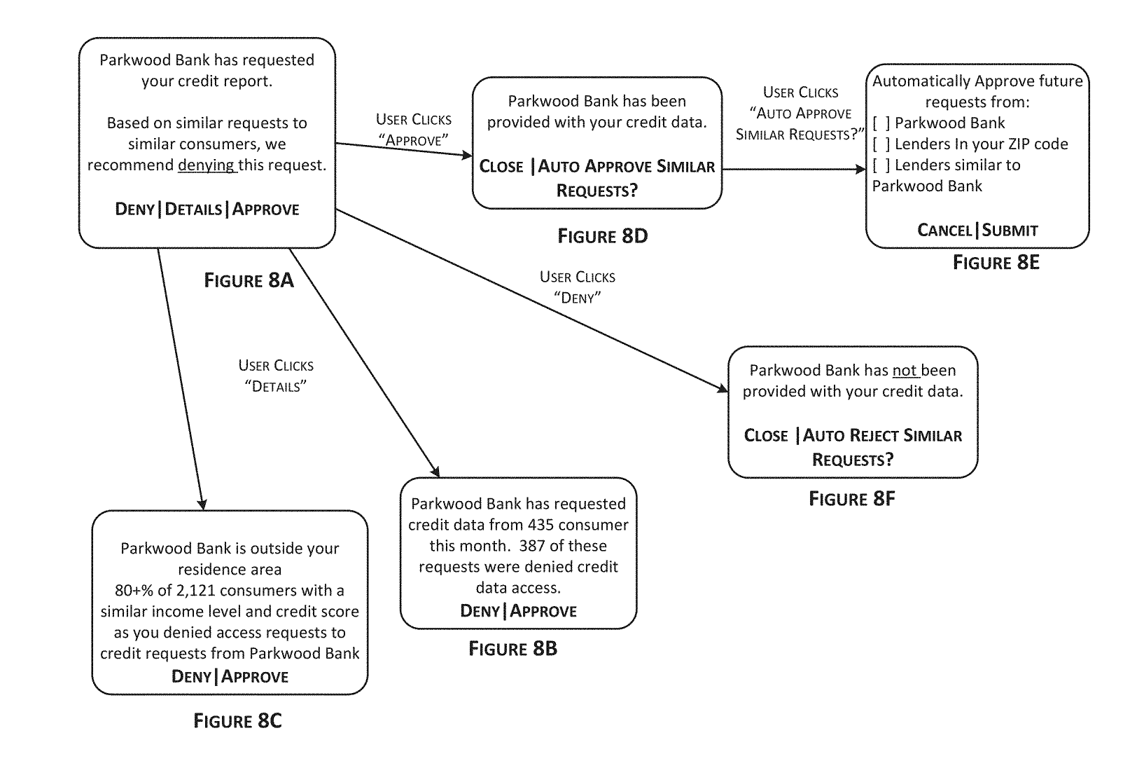

In some embodiments, the user device 162 may transmit a lock or an unlock authorization. The lock or unlock authorization may be sent to the access control system 110, to the credit bureau 104, or any other entity that may perform or process an unlock action on a credit file. The user device 162 may display a user interface allowing the user to select an unlock authorization, which then would send an unlock authorization. Example of user interfaces that may be provided to the user to allow easy, yet secure, access to the user's credit data are provided in FIGS. 7A, 7B, 7C, 8A, 8B, 8C, 8D, 8E, and 8F. In some embodiments, the lock or unlock authorization is automatically determined, such as based on an access control model that considers attributes of the specific requesting entity, the specific user, and/or other factors.

In some embodiments, the user device 162 may automatically send a lock or an unlock authorization based on a user's profile, a community profile, or a requesting entity's profile, which are stored in the profile data store 112. In other embodiments, credit data access authorization alert may not need to be sent to the user, but may automatically be determined (e.g., within the access control system 110) based on the factors mentioned throughout this disclosure (e.g., a user profile, a community profile, or a requester profile). For example, an unlock authorization may be initiated in response to the inquiry request of the credit requesting entity 102 and the user profile may indicate that the user has traditionally allow credit data to be transferred to the entities in the same category (e.g., automobile lenders) as the requesting entity 102 over a certain percentage of times. In this example, the access control system 110 may provide the requested credit data to the requesting entity without (or before) sending any notification to the user.

In the embodiment of FIG. 1, the access control system 110 can (4) make determinations on access to data and/or (5a, 5b) perform actions on a person's data file. For example, the access control system 110 may determine access using information received from the user device 162A. The information received can be historical preference and/or authorization that the user provided. For example, the user may indicate that credit inquiries related to all credit marketing offers are to be blocked. A user can communicate a list of requesting entities that are always allowed access to their credit list, or a list of requesting entities that are always to be denied access. The user can indicate a preference for hard or soft inquiries into their credit files. The user may allow or deny requests for credit data for a particular period of time (e.g., from 10:00 AM PST 1/1/2017 to 2:00 PM PST 1/17/2017). The user can prevent another entity from requesting information for a particular purpose, such as opening an account or for entities related to purchasing a car. The access control system 110 can take this information and generate a user profile that can be applied to an inquiry request for data related to the individual. Then, (5a, 5b) the access control system 110 can determine an action to perform and perform the action based on the user profile. For example, the access control system 110 can alert the user, transfer at least a portion of the credit data, inform the requesting entity that the request has been denied, store and update the user profile, perform a lock or unlock on the credit account, and the like.

In some embodiments, the user profile can be created using a trained model. For example, the system may use a neural network to determine access and/or actions to take. In one embodiment, the neural network can be implemented using an LSTM neural network where training vectors are inputted into the neural network. The LSTM memory cells may retain temporal learner values based on prior states associated with the training vectors. In another embodiment, a back-propagating neural network can be used. Training vectors are inputted into the neural network, and the weights of the neurons are adjusted based on expected output values using optimization methods (e.g., a gradient descent). Other types of modeling (e.g., statistical modeling, a Baysian network) can also be used. Furthermore, instead of training vectors, (A) historical input of user preferences or prior actions may be used to generate the neural network. The trained model can be stored in the trained model data store 114. In some embodiments, the user profile stores information associated with the user. For example, transaction data, credit data, personal information, user history (e.g., historical decisions, etc), training data, and the like.

In some embodiments, a community profile may be created using various rules, criteria, training models, etc. as described throughout this disclosure. The access control system 110 may receive preference, authorization, and/or historical information associated with other users that is used in defining rules for selection of community profiles for particular users and/or credit inquiries. This information may be received through a user device 162, from requesting entities 102, and/or from any of the data accessible to the access control system 110, such as historical credit inquiry access authorizations and denials from various users. This information may also be derived by the access control system 110. The community profile may be created in real-time in response to a request for a user's credit data. Thus, community profiles for a user in response to credit requests from the same entity that are days (or hours or weeks) apart may be different (and may result in different recommended actions) based on changes in the membership and/or member profiles of the determined community.

The community profile may indicate a preference, authorization, or a likelihood of users that share similar characteristics with the user. For example, a community may be identified as users that have retired and have over $10,000,000 in net assets. Historical information related to these users may indicate that they do not want to receive any type of credit marketing offers. Thus, the access control system 110 may automatically block any inquiry requests related to credit marketing offers. Furthermore, if the user shares characteristics similar to characteristics that define the community (e.g., retired and over $10,000,000 in net assets), the access control system may generate an alert informing the user of the preference of other users in the community. The alert may include statistics or percentages that can indicate the level or degree of the preference. This information may be helpful for a user because the user can identify how others similar to themselves are responding to inquiry alerts in general or specific to the received inquiry alert. Providing this information to the user in a real-time alert may inform the user to make a more informed decision.

In some embodiments, a requester profile may be created using a trained model, as described throughout this disclosure. The access control system 110 may receive preference, authorization, and/or historical information associated with other user responses to the particular requester. This information may be received through a user device 162b, 162c. This information may also be derived by the access control system 110. For example, a requester may have a history of sending a large amount of credit marketing offers that a user may not want to receive. Alternatively, a requestor may send a large amount of marketing offers that users have selected. For example, a requesting entity may be tied to a marketing entity (or may be the same entity) wherein their credit marketing offers have had a large percentage of new user sign ups. This may be a good indication that the marketing offers were good (e.g., more relevant, better offers). Having this type of information available to a user, especially in real-time of a transaction, would help the user better able to select the best offer available.

### Example System Architecture

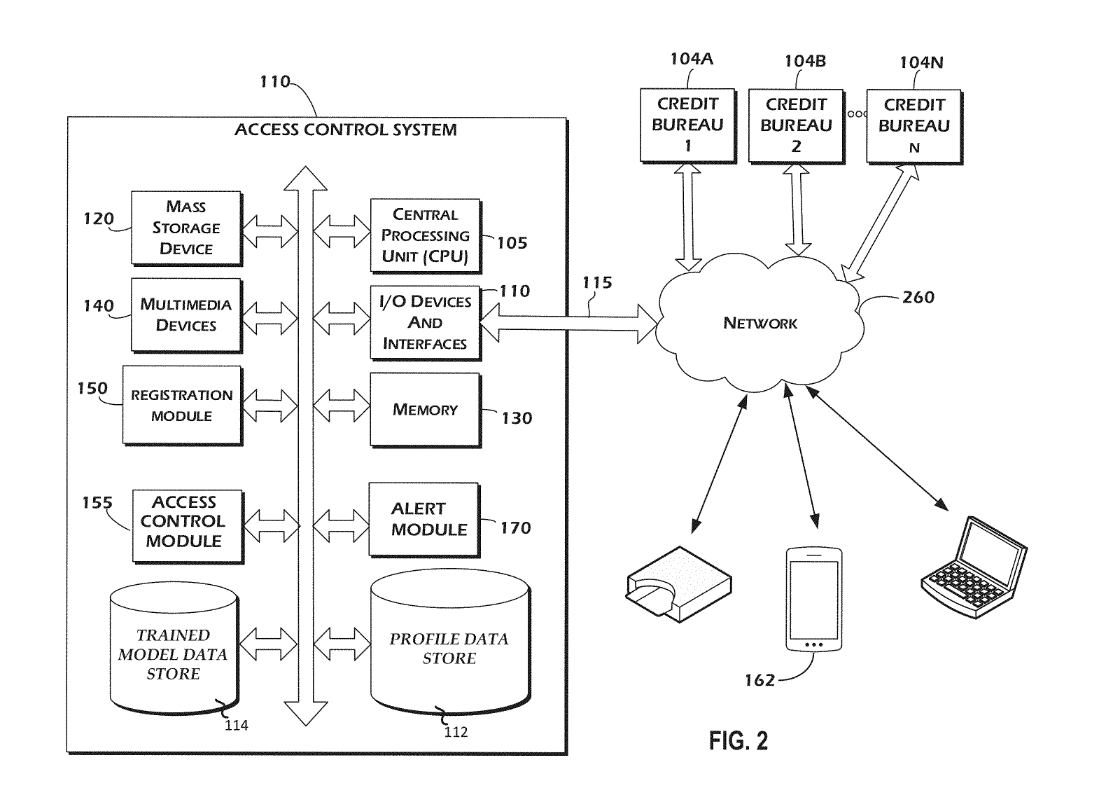

FIG. 2 is a block diagram illustrating one embodiment of a credit access control system 110 that is in communication with user computing devices 162 and a plurality of credit bureaus 104 (including credit bureaus 104A, 104B, 104N that are representative of any quantity of credit bureaus) via a network 260. Generally, the credit bureaus 104 comprise one or more computing systems that gather and make available information about how users use credit, such as a credit score or credit report, for example.

The computing device 162 may be associated with any user, such as an individual consumer, a retailer, an account provider, etc. The user computing device 162 may comprise one or more computing system, mobile device, keypad, card reader, biometric data reader, or other device that allows a user, such as a user, merchant, bank, etc., to exchange information with the credit access control system 110. In particular, the user computing device 162 may allow the user to interface with the access control system 110 in managing access to the user's credit data. In addition, the user computing device 162 may allow the user to unlock or lock credit files at multiple credit bureaus 104 by communicating with the credit access control system 110. In a merchant environment, such as a department store, the computing device 162 may include a keypad, such as a keypad associated with a credit card reader at a store checkout, that allows a user to enter in information to unlock (or lock) their credit files at the plurality of credit bureaus 104 nearly instantaneously and using a simplified process.

The credit access control system 110 may be used to implement certain systems and methods described herein. For example, in one embodiment the credit access control system 110 may be configured to implement a credit file freeze or lock and/or a credit file thaw or unlock process. The functionality provided for in the components and modules of the credit access control system 110 may be combined into fewer components and modules or further separated into additional components and modules. The various computing components and functionality described herein with reference to the access control system 110 may also be included in any of the discussed user computing devices 162.

The credit access control system 110 may include, for example, a computing system, such as a computing device that is IBM, Macintosh, or Linux/Unix compatible. In one embodiment, the computing device comprises one or more servers, desktop computers, laptop computers, cell phones, personal digital assistants, and/or kiosks, for example. In one embodiment, the credit access control system 110 include a central processing unit (“CPU”) 205, which may include one or more conventional microprocessors. The credit access control system 110 may further include a memory 230, such as random access memory (“RAM”), a flash memory, and/or a read only memory (“ROM”), and a mass storage device 220, such as one or more hard drives, diskettes, and/or optical media storage devices. Typically, the components and modules of the credit access control system 110 are connected using a standards based bus system. In different embodiments, the standards based bus system could be Peripheral Component Interconnect (PCI), Microchannel, SCSI, Industrial Standard Architecture (ISA) and Extended ISA (EISA) architectures, for example.

The credit access control system 110 is generally controlled and coordinated by operating system software, such as Windows 95, Windows 98, Windows NT, Windows 2000, Windows XP, Windows Vista, Windows 7, Linux, SunOS, Solaris, or other compatible operating systems. In Macintosh systems, the operating system may be any available operating system, such as MAC OS X. In other embodiments, the credit access control system 110 may be controlled by a proprietary operating system. Conventional operating systems control and schedule computer processes for execution, perform memory management, provide file system, networking, and I/O services, and provide a user interface, such as a graphical user interface (“GUI”), among other things.

The illustrative credit access control system 110 may include one or more commonly available input/output (I/O) devices and interfaces 210, such as a keyboard, mouse, touchpad, and printer. In one embodiment, the I/O devices and interfaces 210 include one or more display devices, such as a monitor, that allows the visual presentation of data to a user. More particularly, a display device provides for the presentation of GUIs, application software data, and multimedia presentations, for example. The credit access control system 110 may also include one or more multimedia devices 240, such as speakers, video cards, graphics accelerators, and microphones, for example.

In the embodiments of FIG. 1, the I/O devices and interfaces 210 provide a communication interface to various external devices. In the embodiments of FIG. 1, the credit access control system 110 is coupled to a network 260 that comprises any combination of one or more of a LAN, WAN, or the Internet, for example, via a wired, wireless, or combination of wired and wireless, communication link 215. The network 260 communicates with various computing devices and/or other electronic devices via wired or wireless communication links.

In the illustrative embodiments of FIG. 1, the credit access control system 110 includes, or may be coupled to, for example via a network connection, an access control module 155 and a device that includes a profile data store 112 for the user, community, or requester. The profile data store 112 for the user, community, or requester may include lock or unlock information that associates users with respective access codes for locking and/or unlocking the user's credit files at each of a plurality of credit bureaus 104. The profile data store 112 for the user, community, or requester may be implemented in any suitable format, including objects, tables, arrays, hash tables, linked lists, and/or trees. The profile data store 112 for the user, community, or requester may be implemented and stored in a database. As used herein, a database may comprise a relational database, such as Sybase, Oracle, CodeBase and Microsoft® SQL Server as well as other types of databases such as, for example, a flat file database, an entity-relationship database, an object-oriented database, and/or a record-based database. The profile data store 112 for the user, community, or requester may be stored in any computer readable medium, including a hard drive, a random-access memory, an optical disc, a tape drive, and/or a diskette.

The information stored by the profile data store 112 for the user, community, or requester may include a user personal identifier (“PID”) that may be selected by a user. In one embodiment, the user PID is associated with multiple credit bureau specific access codes that are associated with the user's credit file at respective credit bureaus 104 and that are configured to initiate locking or unlocking (and/or other access control operations) of the user's credit files at the respective credit bureaus 104. In addition to the components and devices that are illustrated in FIG. 2, the credit access control system 110 may be connected to other data structures that store access codes for user credit files and/or other computing devices through a bus or network 260.

The profile data store 112 for the user, community, or requester may include user lock status of the credit file. For example, the profile data store 112 for the user, community, or requester may include data identifying whether a credit file is frozen, unfrozen, locked, unlocked, thawed, and/or other access controls that the user has requested for the user's credit file. As noted above, a “credit file” and/or “credit data” may refer to an entire credit file of a user, a portion of the credit file, credit data, financial or transactional data, personal data, and/or other data related to an individual.

In some embodiments, the profile data store 112 for the user, community, or requester may store preferences. A user preference may include a preference on actions to take upon an inquiry for a credit file while the credit file is locked or unlocked. For example, preferences may include whether an alert is sent to the user regarding a credit data request by an alert module 170. Preferences may also include the type of information to include in such an alert. Preferences may also include whether an option to unlock the credit data should be included in the alert, and/or may include an automatic unlock of the credit file. The unlock may be customized (e.g., for a particular period of time, for a particular requesting entity, for a portion of the credit file). The preferences may be a default preference, may be inputted by the user, or may be determined based on other relevant circumstances.

The alert module 170 may determine whether the user identity information associated with the inquiry request matches identity information of a member of the credit monitoring service 108. For example, the alert module 170 may be operated by a credit bureau 104, a batch monitor 106, credit monitoring service 108, and/or other provider that provides inquiry alerts to individuals that requested to be members of such a service. In other embodiments, an inquiry alert service as described herein may be offered in association with a related product or service, such that inquiry alerts may be sent to members of the related product or service, provided that the member has not opted out of receiving inquiry alerts. The alert module 170 may determine whether the inquiry request is for credit data of a member of the credit monitoring service 108 (or a related notification service) by determining whether the user identity information extracted from the inquiry request matches member information data retrieved from one or more data stores (e.g., stored by the credit monitoring service 108). In some embodiments, a confidence score may be generated indicating the confidence that the inquiry request is for credit data of a given member. If the confidence score for a given member is above a certain threshold value, the alert module 170 may determine that the inquiry request is for credit data of the given member.

If the alert module 170 determines that that the inquiry request is associated with a member of the credit monitoring service 108 (or a related service), the alert module 170 retrieves contact information associated with the individual. In some embodiments, the contact information may be retrieved from a data store associated with members of the notification service, such that the contact information includes contact details provided by the individual when signing up for the service. In other embodiments, the contact information may alternatively or additionally be retrieved from one or more other data sources, such as from profile data or account data maintained by a third-party service with which the individual maintains contact information and/or other personal information. The retrieved contact information may include, for example, a phone number, email address, mailing address, account name or user name, IP address, or device identifier. In some embodiments, the alert module 170 may additionally retrieve contact preferences associated with the individual, such as information identifying a preferred contact method and/or rules associated with contacting the individual (such as time windows in which the user would like to be contacted, identification of situations in which different contact methods should be employed, etc.).

In the embodiment of FIG. 2, the credit access control system 110 also includes application modules that may be executed by the CPU 205. In the example embodiment of FIG. 2, the application modules include the registration module 250 and the access control module 155, which are discussed in further detail below. In the embodiments described herein, the credit access control system 110 is configured to execute the registration module 250, among other modules, to create a single point of service for users to lock, unlock, or apply further custom access controls on their credit files at multiple credit bureaus 104A-N. For example, in one embodiment, the registration module 250 allows a user to set up the file locking service by creating an account. The registration module 250 may request a user to provide enrollment information, including information that verifies their identity, such as a name, driver's license number, address, social security number, birth date, phone number, account number, and the like. The registration module 250 may then request the user to select a user PID. When the user PID is later provided to the credit access control system 110, the credit access control system 110 may initiate locking or unlocking of credit files of the user at a plurality of credit bureaus 104A-N using access codes associated with the user's credit files at respective credit bureaus 104.

The registration module 250 may further be configured to send requests to the plurality of credit bureaus 104 to obtain access codes and/or other information about unlocking or locking credit files of a registering user. In one embodiment, the registration module 250 may automatically register the user at the plurality of credit bureaus 104 and receive the respective access codes for locking/unlocking the user's credit files at those credit bureaus 104. In one embodiment, an access code authenticates the identity of the user at a particular credit bureau 104 for credit file locking or unlocking. The registration module 250 may store these credit bureau specific access codes in the profile data store 112 for the user, community, or requester and associate some or all of the credit bureau specific access codes of a user with the user PID of the user.

The credit access control system 110 may also execute the access control module 155 to provide a simplified mechanism or interface to lock or unlock credit files at the plurality of credit bureaus 104A-N. In one embodiment, the access control module 155 can receive a user PID that is inputted by a user from user computing device 162, or other device. After receiving the user PID, the access control module 155 may access the profile data store 112 for the user, community, or requester to translate the received user PID into access codes corresponding to multiple respective credit bureaus 104. The access codes may then be sent over the network 260 to corresponding respective credit bureaus 104 to lock or unlock one or more credit files of the user.

In some embodiments, when the credit access control system 110 is operated or associated with one or more of the credit bureaus 104, the user PID may be used to lock or unlock credit files without any translation. This may be particularly advantageous in reducing processing time that

The credit access control system 110 also includes a trained model data store 114. The trained model data store 114 may include the trained model for the trained model related to a user profile, a community profile, and/or a requester profile. For example, the trained model data store 114 may store an LSTM network related to a community for retired people with assets above $10,000,000, and another statistical model for a community for college teenagers living in Washington D.C. The trained model data store 114 may be configured and stored in a similar fashion to that described for the profile data store 112 for the user, community, or requester.

### Example Real-Time Alert and Selective Credit Access Process Based on a User Profile

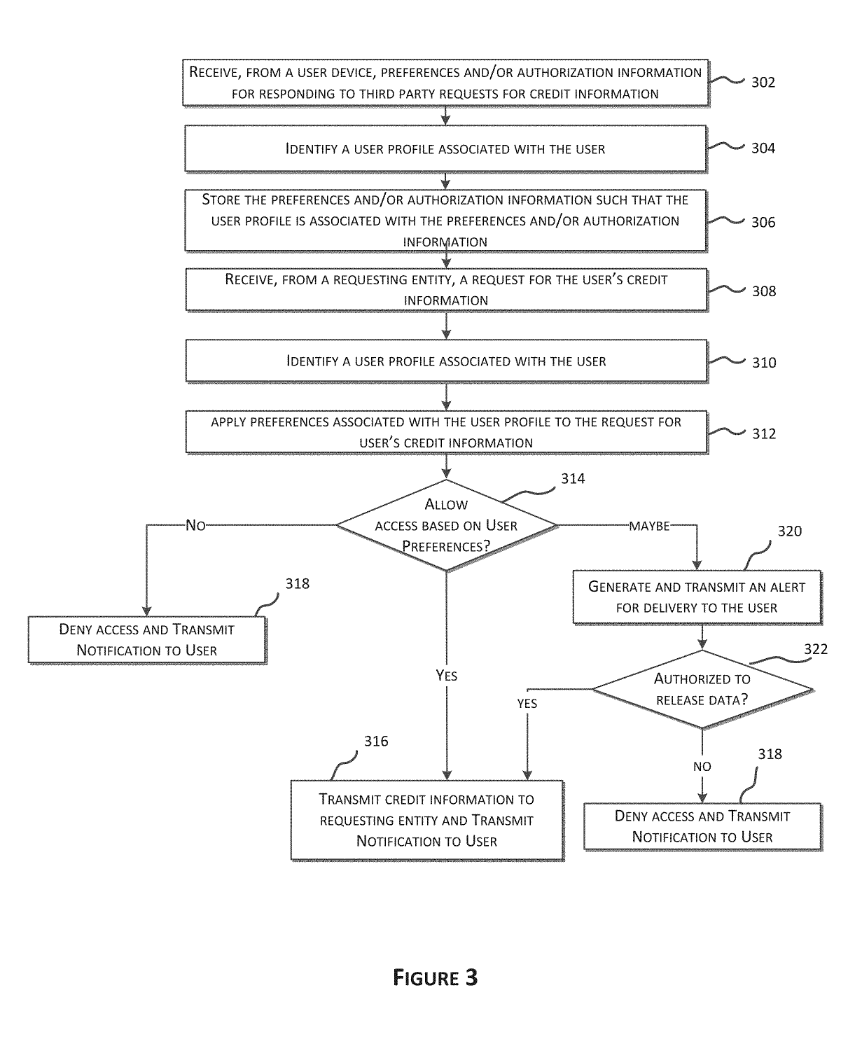

FIG. 3 is a flowchart illustrating one embodiment of a method for determining a response to an inquiry request based on a user profile. Depending on the embodiment, the method of FIG. 3 may include additional or fewer blocks and/or the blocks may be performed in a different order than is illustrated. For ease of discussion, the method of FIG. 3 is described below as being completed by the access control module 155. However, the method may be implemented by any other device, or combination of devices, such as computing devices associated with a credit bureau 104, an affiliate or credit reseller associated with a credit bureau 104, and/or a credit monitoring service 108.

The illustrative method begins at block 302, where the access control system 110 receives preferences and/or authorization information for responding to third party requests for credit information. Preferences may include a user's preference for responding to a particular request. For example, the user may indicate that an inquiry for information by a particular entity or for a particular purpose should always be allowed. In another example, the user may disallow all requests related to credit marketing offers or for hard inquiries for credit data. In another example, the user may prevent anyone else from obtaining credit data for the purpose of opening an account.

In some embodiments, authorization preferences may include an options to automatically provide credit data to requesting entities that present a particular code in the credit inquiry. For example, the user, or a third party, may provide authentication information such as a code that is randomly generated by a third party, a bar code, a QR code, a procedure for authentication, a username, a password, criteria for certain authentication, that a requesting entity may provide in a credit inquiry to obtain instant access to the requested credit data. In some embodiments, different authentication codes and/or methods may be associated with different inquiry request factors, such as the type of information being requested. For example, a QR code may be required for hard inquiries while a password may be required for a soft inquiry. The preference and/or authentication information may be historical information provided by the user, or explicitly provided for the user profile. For example, the information may include historical data of how the user responded to certain inquiries, or how the user provided authentication information in the past. In addition, the information may include a user's explicit preconfiguration to establish a procedure or preference to respond to an inquiry.

In block 304, a user profile that is associated with the user is identified. If a profile is not identified, the profile may be generated or a request for user profile may be generated. Then at block 306, the preferences and/or authorization information is stored such that the user profile is associated with the stored preferences and/or authorization information. For example, the stored user profile may include the preferences and/or authorization information within the user profile or the information may be accessible via a link within the user profile.

At block 308, where the access control system 110 receives an inquiry request requesting credit data associated with an individual. The inquiry request may include, for example, a request for a credit report, a credit score, and/or specific portions or fields of credit data associated with the individual. In some embodiments, the credit inquiry may be sent by a computing system associated with the requesting entity 102 to a credit bureau 104 or credit reseller, which may in turn provide the inquiry or notification of the inquiry to the access control system 110. For example, the credit bureau 104 or credit reseller may operate in a manner in which notification of a credit inquiry is automatically sent or otherwise provided to the access control module when the inquiry is received, such that the access control system 110 may process the inquiry notification for alert purposes in parallel with, prior to, or otherwise without regard to the credit bureau's processing of the request for credit data. In other embodiments, the access control system 110 may receive the credit inquiry directly from the credit requesting entity 102.

At block 310, the access control system 110 analyzes the inquiry request to identify user identity information associated with the inquiry request. In some embodiments, analyzing the inquiry request may include parsing the request to extract user identity information, such as a name, social security number, address, employer, etc. In some embodiments, the access control system and/or the credit bureau, determines a unique identifier of the user identified in the inquiry request, such as by matching identifying attributes in the inquiry request to credit records. In some embodiments, the access control system 110 receives the user information from a third party, such as directly from a credit bureau 104 or a credit monitoring service provider 108. The user identification information is used to identify a user profile, such as a credit file, associated with the user.

At block 312, the preferences and/or authorization information associated with the user profile is applied to the request for a user's credit information (e.g., an access control model is executed), and at block 314 the access control system 110 determines whether to allow the requesting entity access to the credit data. For example, if the request was for a credit marketing offer and the preference was to always allow access to data related to credit marketing offers, then the access control system 110 will determine that the access to credit data should be granted, and proceed to block 316 and allow access to the credit data and transmit notification to the user of the transmission of credit information. In another example, a heightened authorization requirement may be required for automated access to data on a hard inquiry whereas the authorization provided by the user was a username and password. The access control module 110 may determine that a username and password is insufficient to automatically allow such a hard inquiry but requires biometric authentication information. Then based on additional criteria, the access control module 110 may proceed to block 318 and determine to automatically deny access, or proceed to block 320 and generate and transmit an alert for delivery to the user by the alert module 170.

In block 320, the alert module 170 generates an alert for delivery to the individual, where the alert may be generated without regard to credit data associated with the individual. For example, in some embodiments, generation of the alert may be based on the inquiry being received, rather than being based on an identified change to stored credit data. In some embodiments, generating an alert may include storing information indicating that an alert associated with the individual is available, such that the individual will be notified of the alert at a later time, such as during a batch process. In other embodiments, the generated alert may be delivered or otherwise provided to the user immediately after the alert is generated. For example, if an automatic action is determined with a high confidence level, an alert may not be immediately transmitted to the user (but the inquiry may be blocked or fulfilled according to the automatic action), which if a recommended action is determined by access control module, an alert may be immediately transmitted to the user so that a response from the user may be receive to implement (or not) the recommended action.

The information included in the generated alert may be limited, in some embodiments, to an indication that an inquiry has been received regarding the individual. In other embodiments, the generated alert may include details regarding the inquiry, such as information identifying the requesting entity (such as a financial institution or other entity described above), a third party associated with the requesting entity (such as a retail store associated with a credit card issuer that submitted the inquiry), a time and date of the inquiry, the data requested (e.g., whether a full credit report was requested), and/or a geographic location associated with the inquiry.

Once the alert has been generated, the alert module 170 delivers or sends the generated alert to the individual (such as to a computing device associated with the individual) based on received contact information. As will be appreciated, the alert may be provided in a variety of ways depending on the contact information, contact preferences and/or the embodiment. For example, providing the alert may include, but is not limited to, sending a text message (e.g., SMS or MMS), sending an email, making a phone call, leaving a voicemail, sending a letter, providing alert information when the user logs into an account or launches an application, providing electronic messages that activates software components on a remote device, etc. In some embodiments, an alert may be delivered to the individual regardless of whether the inquiry is a hard inquiry of soft inquiry. In other embodiments, alerts may only be provided to the user for hard inquiries. In embodiments in which an individual may receive an alert associated with a soft inquiry, the alert may notify the user that there “may” be a change to the user's credit report, since a soft inquiry might never post to the individual's credit report.

In some embodiments, the alert module 170 may communicate with the credit bureau 104 and/or credit requesting entity 102 to operate in a closed loop manner. For example, in one embodiment the credit bureau 104 may wait for confirmation from the user that credit information may be released to the credit requesting entity 102 before providing the user's credit information to the credit requesting entity 102. For example, the inquiry alert may request that the user respond within a specified time period indicating whether the credit data should be released to the credit requesting entity 102, and may default to either releasing or not releasing the data if no response is received, depending on the embodiment.

In some embodiments, an alert can be generated and delivered to the user. The alert provides the user with the ability to respond to the alert in real-time such that that a response may be communicated to the credit requesting entity 102 to prevent a fraudulent and/or erroneous credit inquiry request. The user has the option to dismiss the alert if the user is aware of a credit requesting entity 102 that may have sent the inquiry request. Alternatively, the user can request more details (e.g., by a link or button provided by the alert on the computing device). In some embodiments, the purpose of the credit inquiry request is stated (e.g., a new credit card application). In some embodiments, other useful information may be added to the alert, such as a time stamp of the inquiry, information regarding the credit requesting entity 102, information detailing risks and steps to take, etc. This electronic alert may include a link or a button that the user can select in order to contact the credit bureau 104 to initiate contact with an agent for further user support. This would allow the users to obtain more information on the credit requesting entity 102 if available, consultation on what can be done going forward, and provide additional options and information. Additionally, the user can initiate a fraud alert, credit file locking, and/or other features via this interface. If the user selects to block access to credit data, then the credit requesting entity 102 may not be notified that the access was blocked. The alert may provide a variety of options for the user (e.g., generating a fraud alert, notifying other credit bureaus 104, requesting additional preference and/or authentication information).

In block 322, the user device 162a may optionally provide a response to the access control module 110. The response may be a user response indicative of user interaction to the transmitted alert in block 320. In the embodiment of FIG. 3, the response may be to allow or deny access to the credit data. If the response is to allow, then the system may proceed to block 316 and allow access to the credit information and transmit an alert to the user device notifying the user. If the response is to deny access, then the system may proceed to block 318 where the requesting entity is denied credit data and the user is notified of the denial of credit data. In some embodiments, the credit data transmitted is provided to the user. In some embodiments, in block 322, user information is provided that is not in response to, or in addition to, the interaction data of the user with the user interface. For example, the user device 162 may provide user history information. The user history information may be used to update the user profile (e.g., update authentication information or preference information provided by the user). For example, the user may have provided biometric information that enables the user to configure additional control over their data or may have modified their preference data. In another example, the user may have performed actions recently that are different from the way the user has in the past. Then, the user profile can be modified to reflect the change in preference. With an updated user profile, the access control system 110 may be able to make further determinations based on an updated trained model.

### Example Real-Time Alert and Selective Credit Access Process in Response to a Credit Block

FIG. 4 is a flowchart illustrating one embodiment of a method for determining a response to an inquiry request in response to a credit block. Depending on the embodiment, the method of FIG. 4 may include additional or fewer blocks and/or the blocks may be performed in a different order than is illustrated. For ease of discussion, the method of FIG. 4 is described below as being completed by the access control module 155. However, the method may be implemented by any other device, or combination of devices, such as computing devices associated with a credit bureau 104, an affiliate or credit reseller associated with a credit bureau 104, and/or a credit monitoring service 108.

The method begins at block 402, where the access control module 155 receives a request from a requesting entity for a user's credit information. Then at block 404, the user profile associated with the user is identified. At block 406, the preferences and/or authorization information associated with the user profile is applied to the request for the user's credit information. If access is to be allowed based on the preferences and/or authorization, then the system proceeds to block 420. If access is to be denied, then the system may deny credit information and notify the user in block 412. If the access control module 155 cannot automatically make a determination to allow or deny access, then at block 414, the system may generate and transmit an alert for delivery to the user. In block 416, if the control access module 155 is authorized to release the credit data to the requesting entity, then the system proceeds to block 420. If the control access module 155 is not authorized to release the data, then the requesting entity is denied access and a notification is transmitted to the user at block 412. The disclosure associated with blocks 308, 310, 312, 314, 316, 318, 320, 322 may apply to blocks 402, 404, 406, 408, 410, 412, 414, 416, where applicable.

At block 420, if the credit file is under a credit block, then the system proceeds to block 422, where the credit file is temporarily unblocked. Then the system proceeds to block 410 to transmit the information to the requesting entity and notifies the user. If the credit file is not blocked, then the system proceeds to block 410 to transmit the information to the requesting entity and notifies the user. In the embodiment of FIG. 4, the access control module 155 may override a credit block (or credit freeze, lock, or other denial of access to credit data) if the access control module 155 determines that the requesting entity be allowed access to the requested data in block 408. In some embodiments, the access control module 155 may not have the ability to override a credit block automatically, but may require additional authorization from the user.

In block 422, the access control module 155 temporarily unblocks the credit file 422. In some embodiments, the access control module 155 does not need to unblock the credit file 422 to send the requested data. In some embodiments, the access control module 155 may perform other actions (e.g., unblock the credit file completely, unblock a portion of the file, unblock the data for a particular purpose or requesting entity, or the like).

### Example Real-Time Alert and Selective Credit Access Process Based on a User Profile

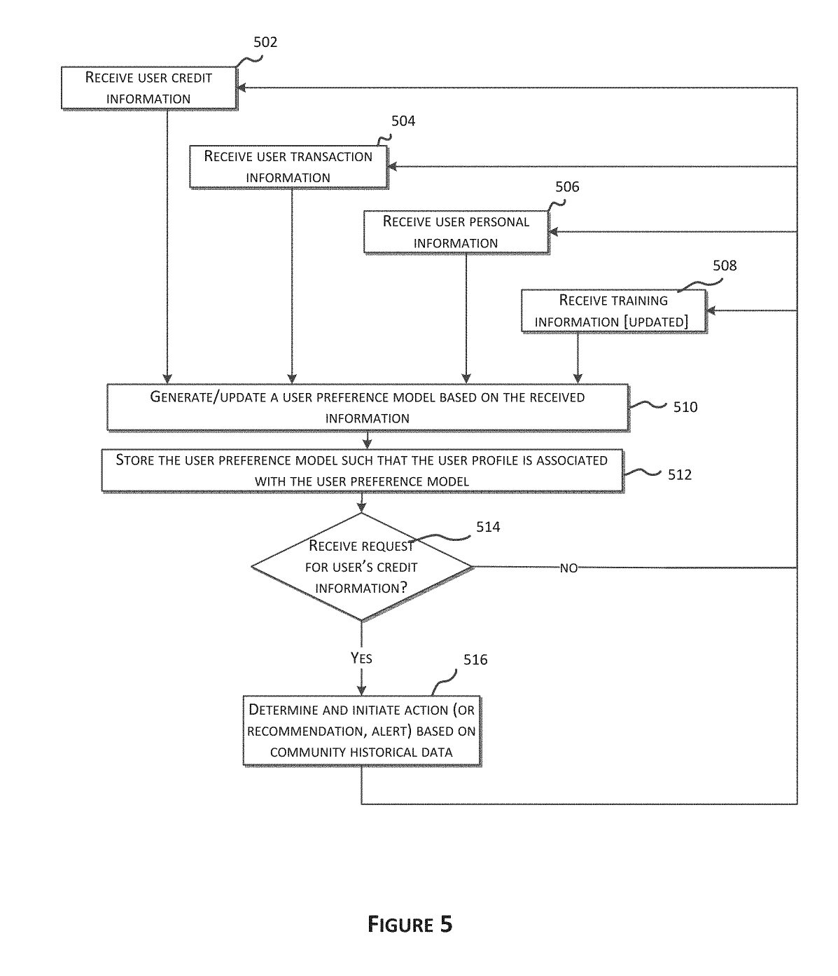

FIG. 5 is a flowchart illustrating one embodiment of a method for generating, updating, and applying a trained model. Depending on the embodiment, the method of FIG. 5 may include additional or fewer blocks and/or the blocks may be performed in a different order than is illustrated. For ease of discussion, the method of FIG. 5 is described below as being completed by the access control module 155. However, the method may be implemented by any other device, or combination of devices, such as computing devices associated with a credit bureau 104, an affiliate or credit reseller associated with a credit bureau 104, and/or a credit monitoring service 108.

The access control module 155 may receive information to be used to generate or update the trained model. For example, and as shown in blocks 502, 504, 506, and 508, the access control module 155 may receive credit information, transaction information, personal information, and/or training information. In block 502, the credit information that is received can be regulated data. For example, the regulated data may include credit information, such as a credit report from a credit reporting agency. In block 504, transaction information may include financial information, credit card data, loan data, application data (e.g., data in a loan application), debt information, payment information, purchase information, or any information that indicates an exchange, an offer, a gift, a payment, a transfer of ownership between two parties, or the like. In block 506, personal information may include any information that is associated with the identity of the user (e.g., a phone number, email address, mailing address, billing address, account name, user name, IP address, device identifier, authentication information, preference information). In block 508, the access control module 155 may alternatively receive training information (e.g., training vector with predetermined output scores) to be used in a trained module (e.g., input into an LSTM neural network).

In block 510, the trained model (e.g., a user preference module) is updated or generated based on the received information. For example, the training information may be used to train the model to output a score that identifies an inquiry for a hard inquiry request and generates a higher weighting indicating a preference to deny the inquiry request. In some embodiments, transaction or credit information is used (e.g., based on total debt or current spending habits, make a determination on inquiry requests). Furthermore, a combination of the received input may be used to train the model. In block 512, the model is stored with the user profile such that the user profile is associated with the trained model (e.g., if the user profile is identified, then the trained model can be retrieved and applied).

In block 514, the access control model 155 determines whether it has received a request for user credit information. If it has not, then in this embodiment, the access control model 155 waits to receive further information in blocks 502, 504, 506, 508 to update the trained model in block 510. If a request has been received, then the trained model is applied. Based on the output of the trained model (e.g., an output score indicative of a certain preference), the access control model 155 may initiate an action, provide a recommendation, and/or generate an alert to the user based on the user preference model in bock 516. For example, the access control model 155 may determine to block or allow access to the requested data, or may request further input from the user or other sources.

### Machine Learning to Dynamically Optimize Access Control Model

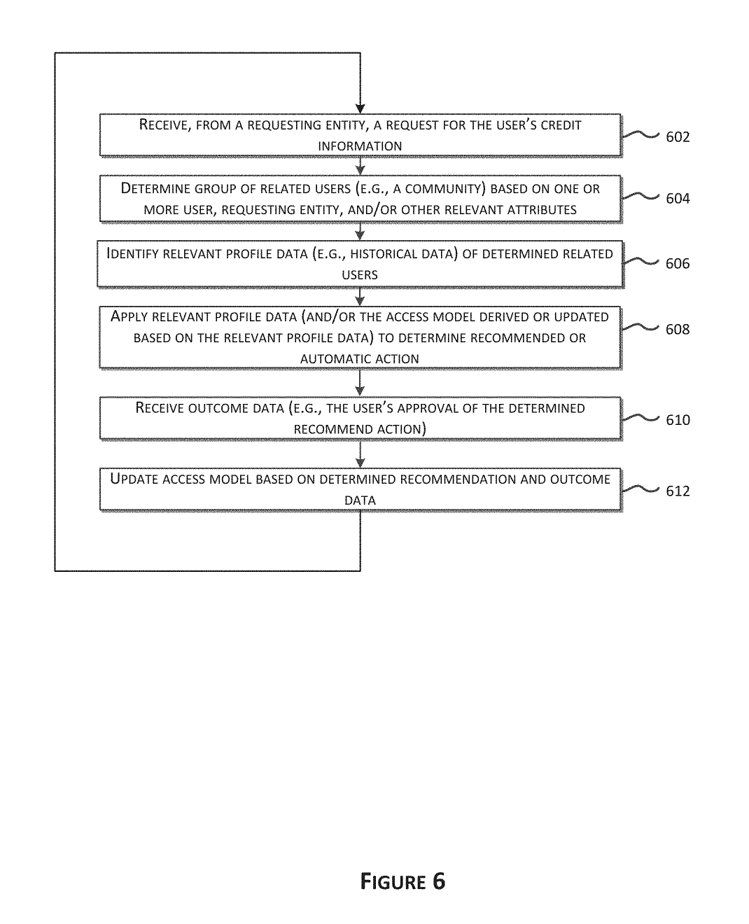

FIG. 6 is a flowchart illustrating one embodiment of a method for optimizing an access control model based on outcome data associated with determined automated and/or recommended actions. Depending on the embodiment, the method of FIG. 6 may include additional or fewer blocks and/or the blocks may be performed in a different order than is illustrated. For ease of discussion, the method of FIG. 6 is described below as being completed by the access control module 155. However, the method may be implemented by any other device, or combination of devices, such as computing devices associated with a credit bureau 104, an affiliate or credit reseller associated with a credit bureau 104, and/or a credit monitoring service 108.

The method begins at block 602, where the access control module 155 receives a request from a requesting entity for a user's credit information. Then at block 604, a group of related users is identified (e.g., a community) based on one or more user, requesting entity, and/or other related attributes. A community may be based on a variety of different factors, as described throughout this disclosure. Thus, a user that has retired and has assets over $10,000,000 may be placed in a community of other users with these same or similar income and residence characteristics. Thus, a community for a particular user may be based on any shared factor or shared set of factors between users. The community may also be based on a weighting of applied factors or applying the factors to a particular algorithm. The preferences or authorization of a community can be defined based on historical information or a predicted determination of preferences or authorization for a particular community.

In block 606, relevant profile data (e.g., historical data) of determined related users is identified (e.g., responses to inquiry requests by users in the determined community). This allows the system to assess how other similar users have responded to inquiry requests in general, or to a particular aspect of the inquiry request (e.g., type of requestor, purpose of request, geographic location of origin of the request).

Moving to block 608, the access control module determines and initiates an automatic action (or recommended action) based on the community data. For example, 80% of users for a particular community may respond by denying an inquiry related to credit card offers. Then, the access control module may automatically deny such an inquiry for users associated with that community. The access control module may generate an alert that notifies the user of such statistics for the particular community. Thus, in block 608 the relevant profile data (and/or the trained model derived or updated based on the relevant profile data) is applied to the request for the user's credit information to generate a recommended or automatic action in response to the request for user's credit information.

In block 610, the access control module receives outcome data associated with the inquiry request, such as the user's approval of the determined recommend or automated action. This outcome data may be indicative of feedback on the automated action taken or recommendation provided by the access control model. For example, the user may make a decision on the inquiry request (or overturn or affirm a decision made by the access control module 155). The user may have the option to view through a variety of different statistics or responses from different communities that the user is associated with. The user may provide comments on the decisions made by the access control module 155. In addition to, or alternative to, user feedback, a portion of a particular community may change their preference or to an inquiry request. Furthermore, a user may or may not want to be identified with a particular community.

Based on the outcome data received, at block 612 the access control module 155 updates the access model based on the determined action or recommendation associated with the related outcome data. For example, an access control model may be updated to be less likely to automatically approve inquiry request from a particular lender (or group of related lenders) in response to feedback from users indicating that they did not want to allow access by that particular lender to their credit data or by the access control model determining that the user has filed a dispute with the particular lender (e.g., by obtaining credit dispute information from the credit bureau and/or a third-party credit dispute handling system). In some embodiments, outcome data includes indications of whether a financial transaction occurred after the inquiry request. For example, if a user took out a loan within a few days of an automatic action of releasing the user's credit data to the lender, the access control model may increase a weighting of automatically allowing access to other user's credit data (perhaps within a community associated with the user) because of that positive experience. Thus, in some embodiments, credit line data of users may be associated with access recommendations or automated actions provided by the access control system in optimizing the access control model.

In the example of FIG. 6, the process repeats indefinitely as credit inquiries are received, recommendations are provided to the corresponding users (e.g., based on a real-time determined community of other users having similar characteristics to the user), and outcome data associated with those recommendations are determined. According, an access recommendation from a particular lender for a particular user may result in different recommended actions at different request times (such as one month apart), based on automatic updates to the access model from other access inquiry recommendations and outcomes over that time period.

### Example User Interfaces & Additional Embodiments

According to the embodiment of FIG. 7A, when a credit inquiry request is identified by the access control module 155, a real-time alert is transmitted to the user's device 162 for which the credit report is requested. In this embodiment, the credit report of the user is provided to the credit requesting entity 102 (if the credit requesting entity 102 has the appropriate permissible purpose to obtain that users credit data), but the user is provided with functionality to obtain details regarding the inquiry request, to obtain details on the credit requesting entity 102, and/or to initiate a fraud alert on the inquiry request. Thus, the user is notified of credit inquiries very quickly and is able to take corrective action quickly.

FIG. 7A shows an alert on a user computing device 162 that may be generated by the command sent from the access control module 155. The alert provides the user with the ability to respond to the alert in real-time so that a response may be communicated to the credit requesting entity 102 to prevent a fraudulent and/or erroneous credit inquiry request. The user has the option to dismiss the alert if the user is aware of a credit requesting entity 102 that may have sent the inquiry request. Alternatively, the user can request more details by a link or button provided by the alert on the computing device 112. In this embodiment, the purpose of the credit inquiry request is stated (e.g., a new credit card application). In other embodiments, other useful information may be added to the alert, such as a time stamp of the inquiry, information regarding the credit requesting entity 102, information detailing risks and steps to take, user historical response, responses of a particular community, users responding to the particular request or requesting entity, etc. This electronic alert may include a link or a button that the user can select in order to contact the credit bureau 104 to initiate contact with an agent for further user support. This would allow the users to obtain more information on the credit requesting entity 102 if available, consultation on what can be done going forward, and provide additional options and information. Additionally, the user can initiate a fraud alert, credit file locking, and/or other features via this interface. If the user selects to block the credit report, then the access control module 155 may request a block on the credit file to the credit bureaus 104.

### Proactive Access Control

FIG. 7B illustrate a sample user interface that may be provided to a user in response to a credit inquiry request, such as in real-time as the inquiry request is received by the credit bureau and/or credit monitoring entity. The example alert indicates that the inquiry request will be automatically blocked if the user does not proactively approve access to the user's credit file. For example, the alert of FIG. 7B indicates a time at which the credit inquiry will be automatically blocked if the user does not provide affirmative approval of the request. In this example, the user is given five minutes from when the alert is provided to the user device. In other embodiments, other time periods and other types of responses, inputs, and/or affirmations may be used. This alert may be provided in response to a preference (or automated recommendation determined by an access control model) that is set for the user or set by the user. In this embodiment, the user is automatically protected from having credit data exposed in the event the user cannot respond to the request for authorization of the credit inquiry request. This type of proactive blocking can be set by the user, can be a default setting for the user, or can provided based on determination of a recommended action by the smart access model (e.g., a determination that access should be blocked, but not at a high enough confidence level to initiate automatic blocking without providing the user a change to allow access).

### Automatic Action

FIG. 7C illustrates an example user interface that may be transmitted to a user device in response to a credit inquiry for which an automated action of denying the inquiry request is determined. As discussed herein, such an automated action may be determined by the access control module 155 (e.g., based on user profile, community profile, access control model, etc.) and automatically determining whether the inquiry request should be fulfilled (e.g., by delivering credit data of the user to the credit requesting entity 102). If the access control module 155 determines that the inquiry should not be fulfilled (or should remain locked or frozen if already locked or frozen), a credit block can be initiated to automatically block the inquiry request and future attempts for credit information, and transmitting communication to the credit requesting entity 102 that the credit data of the user is not accessible. In this embodiment, the user may be spared the difficulty of a credit repair process and/or placing a fraud alert on their credit file if credit data of the user is wrongfully provided to a credit requesting entity 102.

As noted herein, smart access control can also look at other factors (e.g., a user profile, a community profile, a requester profile, the use of a trained model). In some embodiments, these factors identify a trend of responses, a historical percentage or statistic of responses, and/or a prediction of a type of response by the user (and/or other users that share a characteristic with a user). The user can preconfigure the access control module 155 to look for these types of trends, the access control module 155 can automatically identify these types of trends, and/or the access control module 155 can predict the types of trends and request confirmation from the user. The smart blocking function may also use a trained model (e.g., a trained neural network) to identify an action and/or recommendation to make. Thus, the smart blocking module can learn over time how to best automatically handle requests for credit for particular users or groups of users.

### Example User Interfaces Allowing User Feedback and Model Updating

FIG. 8A-E are user example user interfaces that may be provided to a user by the access control system to received input from the user on how to provide access recommendations, receive access instructions from the user, implement updated preferences from the user, etc. These user interfaces may be displayed as push notification, such as via a native messaging application on the user's device (e.g., sms or mms) or via a standalone application (e.g., a credit monitoring service app), such that no matter how the user device is being used at the time the alert is received (e.g., the device may be using another application, in low power mode with the screen off, etc.) to provide the user with immediate notification of the inquiry request and allow further details and/or instructions on responding to be quickly and easily provided. In one embodiment, all of the user interfaces of FIGS. 8A-8F may be provided via text messages (or multimedia messages), such as iMessages, so that the user can quickly view the messages (without opening another application) and interact with the access control system.

In FIG. 8A, an alert is sent to the user computing device providing the user with information on a request for credit information by a third party. In this example, the user is provided with basic information regarding the credit requesting entity 102, such as the name, location, category, specific need for the credit report (e.g., information regarding a particular line of credit or loan the credit requesting entity 102 is attempting to approve). Additionally, the alert can inform the user of the type of credit report or credit data the credit requesting entity 102 is asking for. Because the alert contains more information about the credit requesting entity 102, the individual can make a better educated decision on whether or not the credit inquiry request is fraudulent, or even to allow access to credit information.

FIGS. 8B and 8C are example user interfaces in response to the user requesting for more detail (e.g., user clicking “details” in FIG. 8A). In FIG. 8B, the user interface provides information on the requesting entity (e.g., Parkwood Bank), such as details regarding factors for the recommended action (“denying the request”) in FIG. 8A. As discussed herein, in some embodiments various models, machine learning, etc. pertaining to the user and/or the requesting entity may be used to determine a recommend action and provide information relevant to that determination to the user (e.g., 435 consumer information requested this month, 387 denied access). In this example, the community of the user is other users for which Parkwood Bank has requested credit data within the month. Thus, the user has access to more data than typically available, and can make a better educated decision.

In FIG. 8C, the user interface provides information regarding another community of the user that was determined/used in making the recommendation. As described throughout the disclosure, the community can be defined based on user attributes, the requesting entity, the inquiry, and/or other relevant information. The user interface of FIG. 8C provides information on the requesting entity (e.g., the requesting entity is outside of your residence area) by determining the geographic area of the user and comparing to other users. Furthermore, a second community is determined (e.g., similar income level and credit score), where the user interface can show how other community members have responded (e.g., 80+% of community members with similar income level and credit score denied credit requests from Parkwood Bank). Thus, various communities associated with a user may be determined in response to an inquiry request (in real-time or pre-computed) in order to provide the user with various data relevant to the credit sharing decision.

FIG. 8D is an example user interface that may be provided to a user in response to the user selecting to “Approve” the credit inquiry request in FIG. 8A or in response to a determined automated action to allow access to the user's credit data. In this example, the user interface illustrates an option for the user to update the user's preferences (which may, in turn, updated preferences associated with any communities that the user is selected for membership in), such as to automatically approve other similar requests and/or to deny future request from similar entities.

FIG. 8E is an example user interface that may be provided to the user in response to the user selecting the “auto approve similar requests” link in FIG. 8D. A similar user interface may be provided to the user in response to selection of “auto reject similar requests” link in FIG. 8F. In this example, options of updating preferences of the user for better optimized access control decisioning may be provided by the user. In this example, the user can select options in the user interface to allow the access control model to automatically share the user's credit data, in response to future credit inquiries, with the particular requesting entity (e.g., Parkwood Bank), other lenders in the user's geographic area (e.g., other banks in the user's ZIP code), or other lenders similar to the particular requesting entity (e.g., other banks requesting credit information for purposes of a home loan). In some embodiments, fewer or additional preference options may be provided to the user.

FIG. 8F is an example user interface that may be provided to the user in response to the user selecting “deny” in any of FIGS. 8A, 8B, 8C, or in response to the access control system automatically blocking the inquiry request (e.g., based on the user preferences, one or more community profiles associated with the user, etc.). In this example, the user may select an “auto reject similar requests?” link, which may provide options similar to those discussed with reference to FIG. 8E, but for setting preferences for blocking inquiry requests rather than allowing them.

In some embodiments, the “auto reject” and/or “auto approve” preferences may be auto-populated based on the access control model, such as to provide a recommended preference that the user should set.

In some embodiments, a dashboard user interface may be provided to indicate previous inquiry requests, automated or recommendation actions determined for each, and user authorizations or denials of each. For example, the user interface could indicate the previous block/unblock decisions (e.g., Parkwood Bank denied access 3 minutes ago). Furthermore, the user may be able to provide feedback on the determined automated or recommend action as well as provide further preferences and authorization for future requests for credit data (e.g., allow all requests from Parkwood Bank, allow all requests for lenders in the user's residential zipcode, allow all requests similar to Parkwood Bank).

### Variations and Other Embodiments

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

All of the methods and processes described above may be embodied in, and partially or fully automated via, software code modules executed by one or more general purpose computers. The methods may be executed on the computing devices in response to execution of software instructions or other executable code read from a tangible, non-transitory computer readable medium. A tangible computer readable medium is a data storage device that can store data that is readable by a computer system. Examples of computer readable mediums include read-only memory, random-access memory, other volatile or non-volatile memory devices, CD-ROMs, magnetic tape, flash drives, and optical data storage devices.

Although this disclosure has been described in terms of certain example embodiments and applications, other embodiments and applications that are apparent to those of ordinary skill in the art, including embodiments and applications that do not provide all of the benefits described herein, are also within the scope of this disclosure.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

All publications and patent applications mentioned in this specification are herein incorporated by reference in their entirety to the same extent as if each individual publication or patent application was specifically and individually indicated to be incorporated by reference.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

1. A computing system for automating access to regulated data of a user from a third party requesting entity based on machine learning, the system comprising:
a data store storing a plurality of regulated user profiles, each including user attributes associated with respective of a plurality of users;
a computer processor executing software instructions causing the computing system to:
receive an inquiry request from a third party requesting entity, the inquiry request including personally identifiable information of a user and request for regulated data of the user from a regulated user profile of the user in the data store;
identify a user profile of the user based at least on the personally identifiable information of the user;
determine a plurality of attributes of the user in the identified user profile;
determine a set of other users each having the same determined plurality of attributes, wherein the set of other users have behaviors similar to the user;
for the determined set of other users, access information regarding previous requests for regulated data of the respective other users, the accessed information indicating at least:
entities that requested regulated data of the other users;
for each access request, whether access to the user's regulated data was authorized or denied;
for each access request, whether a relationship between the respective other user and the corresponding requesting entity was formed after the access request;
for each access request, any feedback from the associated other user indicative of whether the access authorization or denial was desired;
based at least on the accessed information, determining an access control model for application to the inquiry request for the user's regulated data;
applying the determined access control model to at least some of the user profile attributes and at least some attributes of the third party requesting entity, wherein an output of the access control model indicates one of:
an automated action of authorizing the inquiry request;
an automated action of denying the inquiry request;
a recommended action of authorizing the inquiry request;
a recommended action of denying the inquiry request;
if the output includes an automated action, initiating the automated action;
if the output includes a recommended action, generate an transmit an electronic notification to the user device, the electronic notification configured to active an application on the user device to display the alert regardless of the current activity of the user device, the alert including a selectable option to allow the inquiry request, a selection option to deny the inquiry request, and at least some of the accessed information regarding the determined set of users that had a significant impact on determination of the output of the access control model.

2. A system comprising:
a data store that stores information associated with one or more users;
a computing device in communication with the data store and that is configured to:
receive an inquiry request from a requesting entity, wherein the inquiry request includes a request for credit data associated with the user;
identify a user profile associated with the user, the user profile storing credit data of the user;
apply a community preference to the inquiry request, wherein to apply a community preference, the computing device is further configured to:
identify a community profile associated with the user profile, the community profile indicating how other users within the community profile previously reacted to inquiry requests;
input data associated with the inquiry request to a trained model for the community profile;
generate at least one output score indicative of the association between a preference of the community profile and the inquiry request, the output score indicative of whether the other users within the community profile would allow the inquiry request or block the inquiry request; and
determine whether the output score exceeds a threshold value;
in response to determining that the output score exceeds a first threshold value, generate an alert for delivery to the user, the alert including:
information identifying the requesting entity;
information indicating that the inquiry request will be blocked without a first authorization from the user; and
a user interface element responsive to touch input of the user to monitor a time period of touching the user interface element, wherein in response to the user touching the user interface element for a threshold time period, a user computing device transmits a first authorization to allow release of credit data of the user to the requesting entity; or
in response to determining that the output score does not exceeds the first threshold value, generate a second alert for delivery to the user, the second alert including:
information identifying the requesting entity;
information indicating that the inquiry request will be allowed without a second authorization from the user; and
a second user interface element responsive to touch input of the user to monitor a second time period of touching the second user interface element, wherein in response to the user touching the second user interface element for a second threshold time period, the user computing device transmits a second authorization to block release of credit data of the user to the requesting entity.

3. The system of claim 2, wherein the trained model is a trained neural network.

4. The system of claim 2, wherein the computing device is further configured to:
update the trained model, wherein to update the trained model, the computing device is further configured to:
obtain interaction history data indicative of a community member's interaction to alerts in response to inquiry requests;
determine, from the interaction history data, a degree of interaction to the inquiry request;
update the trained model based at least in part on the degree of the interaction to the inquiry request.

5. The system of claim 2, wherein the user profile is associated with the community profile based on at least one of: demographic data, sex, race, economic status, age, level of education, income level and employment, psychiatric data, medical data, a personality trait, an interest, values, attitudes, lifestyles, opinions, preferences, likes or dislikes, predilections, purchase history, browser history, browser data, financial history, financial data, credit history, credit data, credit score, or personal history.

6-16. (canceled)
